(19) United States
(12) Patent Application Publication
(10) Pub. No.: US 2017/0002731 A1
(43) Pub. Date: Jan. 5, 2017

(54) System and modality to generate power from liquid jet in heat engine and more

(71) Applicant: YANMING WEI, Mountain (CA)

(72) Inventor: YANMING WEI, Mountain (CA)

(21) Appl. No.: 14/788,884

(22) Filed: Jul. 1, 2015

(51) Int. Cl. F02B 63/04; F24H 1/12; F02B 65/00; F28B 1/06; F02G 1/04; F24H 1/00; F24H 8/00

(52) U.S. Cl. CPC F02B 63/04; F24H 1/0072; F24H 1/12; F24H 8/00; F28B 1/06; F02G 1/04; F02B 65/00

(57) ABSTRACT

Human used to get power from gas expansion in heat engine. Extraction of mechanic work from gaseous expansion is always low efficient, because circa 70% energy is hidden in the exhausted vapor in the form of latent heat and rejected or dumped out of cycle because the slow condensation may choke mass conservative looping. As liquid is hard to be compressed, power transmission can be reasonably assumed lossless, so harvesting mechanic power from liquid flow is high efficient. But historically it is rarely considered for how to form a powerful liquid flow in a typical gas-liquid dual-phase co-existed thermodynamic system, such as the most used Rankine-cycle heat engine. A new method or say Wei heat engine is invented that is based on a new defined Wei second class thermodynamic cycle. Such a new method converts thermal energy into high speed liquid flow during non-equilibrium condensation, though not too much efficient, as well as it jailbreaks the efficient limit of ideal Carnot cycle in an alternative way because the rejected heat is automatically reused to heat base liquid so as to reduce the consumption of heat source.

Based on the said liquid power heat engine, a series of modalities are disclosed, featuring a kaleidoscope of free energy, non-Stirling style external combustion, existing powerplant improving modification, immersed intra-cavitation combustion even with a variety of co-existing ammonia synthesis, and flue gas process with capture of combustion water vapor and carbon dioxide and NOx and sulfur dioxide.

### BACKGROUND OF INVENTIONS

The present inventions relate to energy conversion system, flue gas process for energy optimal utilization plus pollution control, and commensalism of power and heat generation & chemical synthesis.

Human used to get power from gas expansion in heat engine. However, extraction of mechanic work from gaseous expansion is always low efficient, because circa 70% energy is hidden in the exhausted vapor in the form of latent heat and rejected or dumped out of cycle because the slow condensation may choke mass conservative looping.

As liquid is hard to be compressed, power transmission can be reasonably assumed lossless, so harvesting mechanic power from liquid flow is high efficient.

But historically it is rarely considered for how to form a powerful liquid flow in a typical gas & liquid dual-phase co-existed thermodynamic system, such as the most used Rankine-cycle heat engine.

FIG. 1 shows the typical Rankine-cycle schematic diagram. It is estimated that 90% electricity power is generated by such a kind of heat engine, majorly in traditional coal power plant.

A new system and series of modalities will be presented and explained that is based on a new defined Wei second class thermodynamic cycle.

Such a new system converts thermal energy into high speed liquid flow, though not too much efficient, by non-equilibrium condensation, as well as it jailbreaks the efficient limit of ideal Carnot cycle in an alternative way because the rejected heat is automatically reused to heat the working liquid so as to reduce the consumption of heat source.

All prior arts in heat engine suffer from low efficiency circa only or far less than 30%. That results in not only resource waste, but also intolerable environmental pollution.

Every heat engine runs upon a thermodynamic cycle. Most used one is the Rankine cycle. All the existing cycle models do output mechanical work from vapor or gas expansion.

All fossil-fueled heat engines emit large amount of carbon dioxide and water vapor, as well as less but significant other eco-harmful substances, such as sulfur/nitrogen x-oxide, etc.

Another circa 10% energy is buried and wasted in the produced water vapor during combustion or burning, because the latent heat in water vapor is significant. The regular boilers or furnaces just emit and dump the combustion exhaust without reclaiming the vapor latent heat. Especially for burning wood biomass, the latent energy in exhausted water vapor is far larger than the aforementioned 10%, even up to 40%.

It is well known that motive liquid carries kinetic energy, and can be harnessed to payload work efficiently up to 90%.

Generally speaking, there are 2 phases for the working fluid in a heat engine: one is vapor, the other one is liquid.

When vapor becomes liquid, there are 2 possibilities: one is static liquid, the other one is motive liquid. The former is regarded as the regular condensation, the latter as non-equilibrium liquefaction.

Regular condensation is not hard to implement. All current applications are just in this category, for example, power plants even build huge tower for cooling condensation.

Because regular condensation is in slow progress, so it may choke the closed thermo-dynamic cycle, that is why most heat engines are designed to be an open or half-open cycle system, and dump most or all exhausted vapor to atmosphere. In contrast, fuel-economic considered heat engine will dump small partial exhausted vapor only if it chokes the cycle or fail to catch up with power output demand.

The method of non-equilibrium liquefaction does exist, but not too many choices.

At least, a special designed ejector can implement non-equilibrium liquefaction. The more are under process of discovery.

FIG. 2 is a typical ejector cut-away drawing, and its symbol used in this document. It comprises 3 ports: 1 motive fluid inlet, 1 inducted fluid inlet, and 1 discharge outlet.

By the ejector means, though the latent heat in vapor is not 100% converted to the kinetic energy of pumping liquid, the reasonable rate maybe 10%, however all the remains is converted to sensible heat: increasing the temperature of jet blowing liquid, then heating the whole liquid after mixed in tank or reservoir, or indirectly heat the liquid working medium by heat exchanger. Consequently, because of no exhausted vapor emission, the closed thermodynamic cycle can conserve the heat energy after mechanical work extracted, and result in reduction of fuel consumption, then indirectly increase the efficiency of heat engine.

It is the high time to theorize and model a new thermodynamic cycle for such a method.

### SCIENCES BEHIND THE INVENTIONS

How does Ejector or Eductor Work?

Generally speaking, there are 3 ports with an ejector, 2 ports are for input flow, and 1 port is for output. Thereof the 2 input ports, 1 is used for liquid input, the other is for gas or vapor input.

Depending on the design of ejector structure, the pressure range of the 3 ports can be different significantly.

As for power generation purpose, the output port is expected to be seen higher pressure liquid flow. That means the vapor from one of the 2 input ports is expected to be totally condensed dynamically inside ejector after mixed with liquid input flow.

The ideal structure of ejector can make supersonic shockwave happen when input vapor flow entangled with input motive liquid flow. The shockwave energy is from the release of vapor latent heat during condensation. The shock can result in higher output pressure than input pressure of liquid flow, i.e. pressure augmentation.

According to fluid mechanics, as long as there is pressure augmentation with fluid, there will be possibility to generate power.

Because the said pressure augmentation is not as high as the regular hydraulic system of circa 3000 psi, perhaps about 1% to 10%, so that, the regular hydraulic motor is never a good choice for transmitting the ejector hydraulic power. Instead, an open waterwheel turbine is better to harness the ejector′ small scale pressure augmentation.

The velocity threshold of supersonic multi-phase flow is not hard to reach, because the contemporary theory analysis and experiments indicate the typical value about 30 to 40 m/s, even as low as 5 to 10 m/s for special design. Such a velocity range is also good for driving a typical waterwheel turbine.

The shockwave effect greatly depends on how easy and how fast the condensation acts while vapor mixing with liquid inside ejector.

The good condition for condensation is with high temperature vapor to meet low temperature substance—such as liquid, solid surface. The substance can be homogenous i.e. same medium with vapor just in non-gas phase, e.g. liquid water, and its vapor. Of course, high temperature vapor and low temperature liquid mixing together from the 2 inlets of ejector is definitely preferred for easy condensation.

With the condition of supersonic shockwave, the vapor seems very easy to be compressed. As higher temperature follows higher compression, the captured vapor or gas cavity wrapped by liquid is highly compressed with possible extreme high pressure e.g. 1000 bars and temperature, e.g. 5000K reported in cavitation research that results in the unveiling of usual fluid mechanic wearing caused by such a harmful phenomenon.

The collapse of cavitation bubble can be thought of implosion which violence is in the similar order with explosion but centripetally not centrifugally. Because the extreme temperature and pressure will only last the extreme shortest moment and is confined in the extreme tiniest dot space, so it is hard to spread to the whole fluid, and can only contribute micro energy to the average integration effect.

In fact, ejector cavitaion is not native catitation, but invasive cavitation, because most cavitation bubbles are not generated from liquid itself, but directly from inflow vapor mixing stream. Despite different birth of cavitation bubbles, however there is no difference with the extreme temperature and pressure while collapse caused by fierce implosion-like flash condensation or irresistible impact.

Luckily the most extremist temperature is only for insoluble gas that is not a permanent existence in the subject inventions, such as air with principle insoluble N₂ and O₂ gas that may escape while jet flow blowing open waterwheel turbine during starting certain time span. However the cavitation wearing on surface of turbine is still inevitable, what can be done is only to lower the wearing rate by some adequate means.

For soluble gas, such as water vapor, as long as the wrapping water's temperature is under the compressed vapor's dew point that may be not too less than the compressed vapor's high temperature, the non-harmful immature invasive mild cavitation bubbles will disappear or collapse instantly because of quick condensation.

This condition can also be expressed mathematically by:

T_{CompressedVaporInCavitationBubble}−T_{WrappingLiquidAroundCavitationBubble}>ΔT_{threshold}.

So that, even the inlet vapor temperature is less than liquid temperature before mixed inside ejector, though not preferred, it is still possible to be totally condensed quickly when in shockwave mixing condition, and then the released latent heat of vapor can heat the liquid and increase the kinetic energy.

In fact, inside a boiler, the temperature and pressure of vapor are the same with the heated liquid in vicinity of 2-phase interface. So for an ejector power system, at the 2 input portals, the difference of temperature and pressure between vapor and liquid may be not significantly great. But even with such a condition, the non-equilibrium condensation is still possible because the ejector ultrasonic shockwave effect can compress vapor and make vapor temperature high enough for quick condense.

### Is the Free Energy Possible?

The natural background heat always tends to vaporize the surface liquid molecules until reaching saturate vapor pressure. For example, spilled water on ground can gradually dry out. It is just a matter of rate or speed, or climate condition, such as sunny or windy, can make the evaporation faster, otherwise slower.

Not like solar photovoltaic (PV) cell that is only loving direct sunshine, evaporation & transpospiration energy can come from all surrounding heat sources, no matter day or night, even come from working medium itself, though daytime evaporation rate may be greater than night time.

In condition of not sufficient external heat supply provided by solar irradiation or by surrounding atmosphere background heat or by whatever else, as long as the vapor pressure is not saturated, the whole working media will volunteeringly sacrifice itself internal energy to cool down in support of the vaporization occurred on surface, especially the bottom working medium in a container will try to contribute more energy for upper surface vaporization, even risking of substratum frozen. The classic flash vaporization does show such a phenomenon of self-sacrifice.

The contemporary artificial snow generation machine is just built in above rationale. In non-winter artificial skiing resort, such kind of equipment will be installed.

The classic thermodynamic 2^{nd} law asserts that single heat source can not output any power, and that low temperature heat #1 source can not transfer heat to higher temperature heat #2 source.

It should be emphasized that: as prohibition condition, the relationship operator of the two sources is only “#1 source<#2 source”, not “#1 source≦#2 source”, so that means heat transfer may still naturally happen even the two sources have same temperature. This situation will be discussed in next paragraph.

Considering the vapor-unsaturated space always tends to draw more molecules out of surface of liquid, so, underneath liquid is always willing to sacrifice itself internal energy to support surface vaporization in a sensible way of initiative cooling down. This fraternizing sacrifice happens between molecules near the surface with the same temperature, and the heat receiving molecules are going to change phase from liquid to vapor isothermally. This phenomenon is not against the thermodynamic 2^{nd} law, because the law does not prohibit the heat transfer between identical temperature parties with intention of the receiving party phase change.

Then, of course, the ambient “single heat source” has to transfer necessary heat to compensate the cooled liquid, in such a way, the whole “single heat source” will cool down in long time run, only if the heat capacity of the heat source can not be assumed infinite ∞.

Strictly speaking, the assertion of single heat source is not accurate in the subject inventions, because there is the vague second heat source of higher temperature—the transient heat source that bursts dynamically at the moment of wrapping liquid compressing cavitation bubbles of vapor inside the mixing area of ejector. That is why the term “single heat source” in the last paragraph is placed inside quotation marks; in fact it is pseudo single heat source.

As long as there is evaporation, there will be power output, because ejector has the potential of flash condensation so as to generate liquid power via the conversion of latent heat, no matter day or night, though obviously at least 2 heat sources can be seen during daytime—the Sun and the atmosphere environment, but night seems to be misunderstood in “single heat source”—only the atmosphere environment.

The above theoretical analysis has laid the foundation for the possibility to exploit the background heat as free energy, though its broad use in future may result in global cooling!

Such derived apparatus can not be regarded as perpetual motion machine (PPM), because its power comes from the ambient heat, such as the solar energy, wind energy, atmosphere internal energy that is accumulated during the sunshine, and even evaportranspiration energy. In other words, it neither first class PPM, nor second class PPM.

### Liquid Power Rating

Analog to that electric power wattage equals to voltage multiply by ampere, the power of liquid flow equals to pressure drop multiply by flow rate, the equation:

PowerOfLiquidFlow=PressureDrop*FlowRate

In regular heat engine with prior arts, the temperature and pressure of vapor is always pushed to as high as possible for large expansion power and energy density. Contrastingly, the liquid power heat engine can not expect too greater output pressure than input, so for generating high power, big effort should be focused at increasing the flow rate. That also means the size of ejector should commensurate with the power rating.

In aforementioned equation, there exists:

PressureDrop=EjectorPressureAugmentation∝MassOfCondensedVaporPerSecond.

The condensation rate is the base for the system capacity rating.

Given the water vapor minimal releasable latent heat is about 2.1 MJ/kg, for every 1 kw thermal output capacity, i.e. 1000 Jules per second, condensation rate should be 1000/(2.1*10⁶)=0.0005 kg/s=0.5 g/s, that means at least 0.5 grams vapor should be condensed to liquid water per second per kilowatt while ejector shockwave occurs.

The mechanic work capacity is more concerned, but generally speaking, it is about 10% to 30% discount of the thermal capacity. That means most of energy still exists in thermal state after liquid jets out of the ejector, only a small partition exists in liquid kinetic energy. Even so, do not feel regret, because the thermal energy is conservative in the system without waste.

So, the mechanic work capacity rate can be estimated in vapor condensation rate from (0.5 g/s/kw)/10%=5 g/s/kw to (0.5 g/s/kw)/30%=1.7 g/s/kw, averagely circa (5+1.7)/2=3.4 g/s/kw.

In clear and short words, ejector-based heat engine capacity rate is equivalent to the vapor condensation rate: 3.4 g/s/kw.

As no question for the pressure gain with ejector, the next step is to harness the liquid power.

Just like hydroelectric plant, a turbine is desired to transmit liquid energy to drive electricity generator. The waterwheel with the style of Pelton spoons is a good turbine choice.

Some kinds of positive displacement pump can be reversely used as liquid motor in ejector power system, such as progressive cavity pump, screw pump, etc.

By cascading ejectors, a liquid power heat engine system can simultaneously play vacuum function to cope with industrial application. In the vacuum purposed ejector, or say eductor, the gas input port is hooked to sealed vessel or container, and all inside gas will be entrained out with the primary motive flow.

### Need a Starter?

Liquid power heat engine may need a starter because motive liquid flow needs power to initialize it before the pressure increased output port can feed back power to motive flow input port. The starter can be powered by hand crank or by battery.

The starter can be inline fitted as a pump with parallel bypass valve. After the system started, the bypass valve is always open.

The turbine, plus the starter pump with bypass, combined with the ejector's motive liquid input port, liquid output port and liquid tank, forms a close low-head liquid flow circuit.

Another Interesting Science is Concerned with the Siphon Phenomenon.

Immersing one end of soft tubing under water, as long as the other end is below the water level, then giving a starting suck, the running water flow will be sustainable until the water container is empty, and elevating the outlet above water level will stop the siphoning.

With the application of 3 ports ejector and inserting it into the regular siphon line, below-the-water-level is no longer a have-to condition, even reasonable height above water level is allowed, as long as adequate vapor stream is sucked from the second inlet, because the released latent heat in vapor will increase the output pressure.

Such a property can be defined as quasi-siphon, even pseudo-siphon phenomenon. It will be used in my inventions in order to create a sustainable liquid flow.

### How Much is the Water Vapor Emission?

Take the exhausted gas of gasoline combustion as an example:

C₈H₁₈↑+12.5(O₂↑+3.78N₂↑)→8CO₂↑+9H₂O∇+47.25N₂↑

The octane C₈H₁₈ is the principle component of gasoline.

Burning 1 mol octane needs 12.5*4.78=59.75 mol air. Given the mol mass of octane is 114, so the theoretic mass ration of fuel to air is: 114/(12.5*(32+3.78*28))=6.62%, total generated mol in the equation is 8+9+47.25=64.25.

The different component in flue gas takes different proportion by mol ratio as follows:

CO₂: 8/64.25=12.5%; H₂O: 9/64.25=14%; N₂: 47.25/64.25=73.5%
or the ratios by mass:
CO₂: 19.2%; H₂O: 8.8%; N₂: 71%

Calculating by mass, then for every 1 kg CO₂ emission, the H₂O emission is about 0.46 kg. For other fuel, such as diesel, coal, etc., the calculation result does not differ much.

Generating 1 kilowatt-hour electric energy by fossil fuel will generate about 1 kg CO₂, so it can be imagined or calculated how much combustion water vapor produced in whole world.

Considering the greenhouse effect, the carbon dioxide is often thought as culprit, and attracts great public attention, though in fact, water vapor can impact much more than carbon dioxide. This may be caused by the unverified assumption that the water vapor will be quickly condensed into rain and precipitate quickly.

As to my study, not 100% evaporated water will fall down in short time; some proportion may always stay in higher sky, then ignoring the water vapor's contribution to greenhouse effect is technically not wise!

So reclaiming the combustion water from hot flue gas in situ will function profoundly in quenching global warming and improving air quality.

And also the latent heat in vapor is significant circa 10% of total thermal energy, as well as fresh water in some area also a valuable resource, so lots of credits are there.

### Is Latent Heat of Cold Vapor not as Powerful as Hot Vapor?

The answer is NO!

By intuition, you may probably give the answer to hot vapor, but the right answer should be the cold vapor if careful calculation done.

From any thermophysics handbook, you can get these data: for the 0° C. water vapor, latent energy=2374 kj/kg; for 25° C., reduced to 2304 kj/kg.

You can also get: for 101° C. vapor or say steam, condensation will release latent energy=2507.2-423.3=2084 kj/kg. Obviously it is less than 2374 kj/kg in 0° C.

The relevant experimentalists even suggest an empirical formula in cubic function:

L_{water}(T)=(2500.8−3.36T+0.0016T²−0.00006T³)kj/kg,

where the temperature T is taken to be the numerical value in C.

The differential function:

$$\frac{d L}{d T} = - 3.36 + 0.0032 T - 0.00018 {T}^{2}$$

Obviously, in regular temperature range,

$$\frac{d L}{d T} < 0 ,$$

and that means the higher the temperature, the lower the latent heat. So don't despise cold vapor anymore!

Above calculations clearly demonstrate the powerful energy hidden in our daily breath air.

For ejector liquid power heat engine, too high temperature even risks of spoiling the efficiency because such application is mainly intended to exploit the latent heat of vapor and latent heat may decrease as temperature increases.

In contrast, the regular heat engine is exploiting the internal energy of vapor, i.e. the higher the temperature, the higher the efficient, and the Carnot cycle efficiency is the max value for the same working temperature range amongst all different model heat engines.

### Evaporation Rate and Energy Equivalence

In average year, for a typical district of 1000 mm precipitation per year, every square meter land will roughly evaporate water 1000 mm/365=2.74 mm/day in average, it is equivalent to 1000*0.00274=2.7 kg/m²/day, or 2.7*2.3=6.2 MJ/m²/day, or 6.2*10⁶/(24*60*60)=72 watts/m², or 0.072*24=1.7 kwh/m²/day. All those should be credited to the contribution of the Sun cooking the Earth.

By changing the time scale to second, the 2.74 mm/day is equivalent to 2.74/(24*60*60)=3.2*10⁻⁵ mm/s=32 nm/s, i.e. 32 nanometers per second in thickness reduction.

The diameter of water molecule is about 0.4 nm, or 4 Å (angstrom). So, year-averagely speaking, 32/0.4=80 layers of water molecular on surface will be vaporized in 1 second.

Theoretically the water evaporation rate is proportional to (saturated pressure−real vapor pressure), temperature. In real word, lots of factors in effect, even include wind velocity, so it is complicated very much to deduce an official formula. However there exist a few of empirical formulas.

For example, the EngineeringToolbox website proposes an empirical equation:

Gs=(25+19v)A(Xs−X)/3600

The v is the wind speed.

A is the water surface area.

Xs is the theoretical ratio of mass of water in saturated air; X is the real respective value.

### EXAMPLE

### Evaporated Water from a Swimming Pool

For a swimming pool with water temperature 25° C., the saturation humidity ratio is 0.02 kg/kg. With an air temperature of 25° C. and 50% relative humidity—the humidity ratio in air is 0.0098 kg/kg.

For a 25 m×20 m swimming pool and 0.5 m/s velocity of air above the surface, the evaporation amount can be calculated as:

$${G}_{s} = ( 25 + 19 ( 0.5 m \text{/} s ) ) ( ( 25 m ) ( 20 m ) ) ( ( 0.02 kg \text{/} kg ) - ( 0.0098 kg \text{/} kg ) ) / 3600 = 0.049 kg \text{/} s .$$

The evaporation rate in thickness change is about 0.049/((25*20)*1000)=10⁻⁷ m/s=100 nm/s.

If the air is totally dry, i.e. the relative humidity 0%, the calculated 100 nm/s will be doubled.

In ejector based heat engine application, the vapor is inducted inwards by motive liquid flow. That will make the quasi-vacuum status and boost the evaporation rate greatly!

### Asakawa Effect—a Method to Quicken Evaporation

In 1976, Asakawa Y. found that special deployed electric field can promote the rate of water evaporation up to 10 times faster than natural condition.

The preferred setting is to sit evaporation pan on a big size electrode plate, as well as the other electrode is hanging above water surface at reasonable height, e.g. 10 mm.

Nowadays this scientific discovery is widely applied in many industries, e.g. food drying.

Experiments show that the alternator current (AC) voltage is better than direct current (DC). Because the dielectric materials water and air between 2 electrodes acts as a capacitor, so the electric energy consumption is very small.

Compared DC electric field, applying AC electric field will consume more energy, because the former only charge the capacitor, but the latter there will be constant AC current amperage in the high voltage loop. The AC amperage will disperse some energy in the equivalent leaking resistor. In my point of view, it is just the said consumed electric energy that promotes the evaporation rate in great efficiency in an amplified leverage.

The evaporation boosting efficiency of electric field is far higher than traditional heating method, even may show a little touch of overunity.

FIG. 7 shows that the circuit loop in electric-field aided evaporation is equivalent to a simple serial loop comprising a resistor and a capacitor.

Stoichemistry of Sequestration of CO₂ and NOₓ and SO₂ from Flue Gas Emission

Carbon dioxide, nitrogen oxide/dioxide, sulfur dioxide can be sequestrated in many ways.

Here just enumerate some chemistry equations related to the sequestration process (ΔH stands for enthalpy of reaction):

Ca(OH)₂+CO₂→CaCO₃+H₂O(ΔH=−69.8kj or 944kj/kg, exothermic)

CaCO₃+H₂O+CO₂→Ca(HCO₃)₂
(ΔH=−40.64 exothermic, ≈water condensation latent heat)

### Solvay Process to Fix Carbon:

NaCl+NH₃+H₂O+CO₂→NaHCO₃+NH₄Cl(ΔH=−1154 exothermic)

2NaCl+2NH₃+H₂O+CO₂→Na₂CO₃+2NH₄Cl(ΔH=−1374 exothermic)

NaHCO₃→Na₂CO₃+H₂O+CO₂(ΔH=1294 endothermic)

Ca(OH)₂+2NH₄Cl→CaCl₂+2NH₃+2H₂O(ΔH=914 endothermic)

### Fixing Nitrogen:

2NO+O₂→2NO₂ (ΔH=−1144 exothermic)

3NO₂+H₂O→2HNO₃+NO(ΔH=−1384 exothermic)

### Fixing Sulfur:

2SO₂+O₂→2SO₃ (ΔH=−1984 exothermic)

SO₂+H₂O→H₂SO₃ (ΔH=−524 exothermic)

SO₃+H₂O H₂SO₄ (ΔH=−2284 exothermic)

### Ejector Working as a Chemical Reactor

In order to use ejector as chemical reactor, the designed chemical reaction should be easy to occur and complete, especially spontaneous type is the most-wanted, because all fluid molecules are to stay inside ejector in short time.

Generally speaking, the strong acid and strong alkaline is a good match.

The 2 inlet ports of the ejector intake one liquid reactant and one gaseous reactant, the liquid resultant or product jet flow blow out of the only outlet port.

The reaction should be the type of exothermic, so that to generate resultant jet power. The greater is the ΔH (enthalpy of reaction), the easier and faster the reaction.

The shockwave phenomenon may be far stronger than the regular water and vapor, because chemical reaction releases more energy than vapor condensation. In fact, the ejector mix area is perfectly fluidized in favor of fast and complete reaction.

### Introduction of Innovative Thermodynamic Cycle

I present a new thermodynamic cycle, and name it as “Wei second class thermodynamic cycle”, short formed as “Wei-II cycle”.

According to another my prior patent application: U.S. patent application Ser. No. 14/555,378, the term “Wei first class thermodynamic cycle” has been defined thereof, and It will be cited with title and other information in this application in prior arts section.

The Wei-II cycle is a modified Rankine cycle where power output is shifted totally or partially from gaseous expander to liquid turbine that is driven by augmented hydro-dynamic pressure. Hydrodynamic pressure augmentation can be gained by non-equilibrium vapor condensation or other means of flash condensation.

For backward compatibility, as an option, the traditional gaseous expander can still be kept, and the liquid power will then function as second output in a retrofit modification plan.

Vapor overheating is another option in this kind of thermodynamic cycle. It may depend on whether the optional gaseous expander exists. If the said expander exists, the vapor or say steam is always expected to reach as high temperature as possible, so overheating the vapor in a separate stage makes it far away saturate state for more power output, as well as in first stage, maintaining the liquid and vapor coexisting boiler not too high temperature for easy ejector non-equilibrium flash condensation during liquid power output.

The Wei-II cycle diagram is showed in FIG. 3 and FIG. 4. There is minor difference therein: the former shows Wei-II cycle engine rationale sketch with liquid motive flow; the latter Wei-II cycle engine rationale sketch with steam motive flow.

A regular existing heat engine can be modified to inline a secondary power sub-system while the main gaseous expander is still working. No matter prior open system or closed loop system, it will be a new closed loop system after modification, and the efficiency will be greatly improved.

The combustion flue gas can be routed to liquid power extraction sub-system, then the water vapor inside flue gas can be condensed to the output liquid flow, as well as latent heat is scavenged even with the possibility of simultaneously capturing the carbon dioxide in nonvolatile compound.

In the scenario of combustion flue gas participated Wei-II cycle, if the working medium is water, then theoretically the mass of working medium will increase gradually because burning fossil fuel will contribute extra water into the whole system. This variety cycle is defined as mass-added closed Wei-II cycle.

With this modification, the commercial power plant can benefit from huge fuel saving, as well as no surplus waste heat, even no more carbon dioxide emission, plus environmental pollution will be greatly reduced.

### Prior Arts

The ejector's phenomenon of pressure augmentation has been explored long time ago, and it is exploited only in heat supply system nowadays.

Most applications are involved in space heating with the reclaim of exhaust vapor of gas turbine, therein the key component ejector intakes the exhaust vapor and low temperature liquid water, then hotter water is generated and the augmented pressure circulates the hot water into heat consuming space along closed loop and return to ejector without a dedicated circulation pump.

Where the exhaust vapor of gas turbine is not accessible, currently solar heating tube is most likely used to generate fluid in similar thermal grade. In this variety, the application is intended for refrigeration and/or heating simultaneously.

All prior relevant patents are based on gaseous turbine or expander to output power, no found of similar patent that harvests power from liquid flow in any type of thermodynamic heat engine application, so hereby only quasi-relevant citation can be given as follows.

### CITED PATENTS

U.S. Pat. No. 4,843,823—Use of ejectors for high temperature power generation, Apr. 9, 1987.
U.S. Pat. No. 4,439,988—Rankine cycle ejector augmented turbine engine, Nov. 6, 1980.
CN 102635416 A—Low-grade thermally-driven Rankine power generation device with ejector, Apr. 17, 2012.
CN 102562179 A—Organic Rankine cycle power generation system with liquid ejection device, Jan. 17, 2012.
CN 202937321 U—Air-exhausting-then-hot-ejection type organic Rankine cycle (ORC) system, Dec. 6, 2012.
U.S. Pat. No. 5,565,067 A—Evaporation of water using high frequency electric fields, Mar. 31, 1994.
US 20100196244 A1 Method and device for binding gaseous CO₂ to sea water for the flue gas treatment with sodium carbonate compounds, Mar. 15, 2007.
U.S. Ser. No. 14/564,711 A—System and method to scavenge latent heat and freshwater from air and more, Dec. 9, 2014.
U.S. Ser. No. 14/555,378 A—Apparatus of quasi-laser induced by vapor condensation and 2 thermodynamic cycling methods, Nov. 26, 2014.

### CITED PUBLICATIONS

Analysis of a solar-assisted ejector cooling system for air conditioning—by Int. J. Low-Carbon Tech. (2009) 4(1): 2-8.doi: 10.1093/ijlct/ctn001, first published online: Jan. 1, 2009.
Collector selection for solar ejector cooling system—by Solar Energy, Elsevier Science Ltd., Vol. 64, Nos 4-6, pp. 223-226, 1998. 1998.
Supersonic nozzle flow in the two-phase ejector as water refrigeration system by using waste heat—by 9th international conference on heat transfer, Fluid Mechanics and Thermodynamics 2012 [152], Journal of Physics: Conference Series 433 (2013) 012018 doi:10.1088/1742-6596/433/1/012018/The Irago Conference 2012 IOP Publishing.
Thermodynamic performance of a combined power and ejector refrigeration cycle—World Academy of Science, Engineering and Technology Vol:7 2013-07-20.
Steady-state analysis of the solar-driven ejector refrigeration system using water, methanol, ammonia as a refrigerant—International Journal of Emerging Technology and Advanced Engineering, website: www.ijetae.com (ISSN 2250-2459, Volume 2, Issue 9, September 2012).
A comparative performance of Freon ejector refrigeration systems—1990 international refrigeration and air conditioning conference.
A 1-D analysis of ejector performance—by International Journal of Refrigeration 22 (1999) 354-364.
Review of solar refrigeration and cooling systems—Energy and Buildings volume 67 (December 2013) pp 286-297.

### THE DETAIL DESCRIPTION OF INVENTIONS

Hereinafter, the aforementioned sciences behind different inventions will cast its shade in respective presented innovative system and modalities plus preferred embodiments.

All systems and modalities and their embodiments contain or have connection with at least one ejector. Different geometric parameters configuration may constrain performance and the possible output power rating, even the scope of the respective application.

Sometimes, the geometric data even is looming as delicate as finger print, and sensitively affects the performance of intended applications.

There will be some optimized configurations that can achieve the best efficient. By traversing all possible combinations via experiments in situ or laboratory, the optimized or relatively optimized configuration can be found in a hard effort.

### Invention 1: The General Modality of Ejector Based Wei-II Cycle Heat Engine.

According to upper context, Wei-II cycle Engine is a kind of modified Rankine cycle heat engine that can extract power from kinetics or momentum of liquid flow.

The innovative modality of power generation can be configured based on the aforementioned Wei-II cycle. The so-built embodiment is defined literally as Wei-II cycle heat engine.

The Wei-II cycle engine can work on many different heat sources, such as flame of external combustion of fossil fuel or biomass or the other likes, waste heat, solar heat, climate background heat etc. Thereof, if the heat source is just from solar radiation, or atmosphere accumulated heat, then the modality features the clean energy utilization.

As no commercial fuel used in this clean energy system, so it can also be referred to free energy, though the root energy comes from the solar energy.

For the non-clean energy, the mainstream is the traditional fossil fuel, and as an advantage of this invention, flexible external combustion is easy to be embodied.

Dedicated ejector can create the condition of pressure augmentation between inlet and outlet in same liquid phase with the non-equilibrium condensation effect to convert and utilize latent heat hidden in vapor stream inducted from the second inlet, and then the pressure augmentation combined with the flow rate can generate mechanical work, so a well designed ejector can be used to extract liquid power, so as to implement a Wei-II cycle heat engine.

Except ejector, there may be many other possible methods to support implementation of the Wei-II cycle. As my research is concentrated on ejector based utilization, I only describe and claim that is based on one ejector or a plurality of ejectors.

I encourage other inventors to research how to build a Wei-II cycle heat engine that is not based on ejector.

### Modality Deployment Dependent on Power Actuator

There are multiple choices for the type of liquid power actuator. Basically the actuator can be categorized in 3 classes:
A. Unsealed or open liquid turbine that is exposed to ambient air. If working medium is water, then it can be called as waterwheel.
B. Sealed liquid motor or say hydraulic motor. Low pressure and high flow rate are preferred.
C. Inline helical screw liquid turbine that is embedded in expansion segment of an ejector. Logically it is combination of ejector and the class-A or class-B turbine.

Whatever actuator used, a whole modality can have 2 dependent fluid circuits.

One is the ejector inlined liquid power circuit with buffering holding space and overflowing mechanism: EjectorPrimarylnlet—EjectorOutlet—PowerOutputActuator—BufferingContainer—EjectorPrimarylnlet. It is also referred to turbine loop for convenience, as well as open turbine loop for class-A modality, or sealed turbine loop for B.

The other one is the speculative fluid mass transfer loop: Boiler/Evaporator—EjectorSecondarylnlet—EjectorOutlet—OverflowingPort—Boiler/Evaporator. It is also referred as main loop for convenience.

In fact, the above 2 circuits are closely dependent. The main loop carries or transfers mass and heat in whole system circle, as while as the turbine loop is only local around ejector. The turbine loop can be regarded as a sub-loop of main loop, and they are bridged or coupled by the ejector and overflow mechanism.

The overflowing mechanism can not only be implemented by check valve inside boiler or evaporator, but also by liquid pump installed between buffering container and boiler, and the former can automatically maintain the liquid level of buffering container for less fluctuation, as well as the latter for more fluctuation because starting and stopping pump too frequent will impact the system efficiency.

For the modality with class-B actuator, buffering container is not necessary, and check valve overflowing mechanism is the only option. Buffering container or tank is only necessary for modality with open liquid turbine or waterwheel.

The class-C actuator can either have a buffering tank or not, all depend on application.

The regular hydraulic motor is never a good choice for the desired sealed hydraulic motor in the innovative modality of power generation, because its working pressure circa 3000 psi is so high that the ejector is hard to gain. The ideal one should be low pressure and high flow rate.

Not only pressure mismatch, but also the regular hydraulic oil is sticky and hard to evaporate. Water medium is desired for the ideal wanted low pressure hydraulic motor.

The market for this kind of hydraulic motor is still not ready, though many new researches are under progress.

### Insoluble Gas Purging

The open liquid turbine loop is also good for eliminating unwanted insoluble or simply unwanted gas, such as nitrogen N₂, Oxygen O₂, carbon dioxide CO₂, etc.

The initial running stage after started cannot guarantee no air mixed with vapor of working medium. The insoluble nitrogen will enter ejector, then get out of ejector from outlet port, and will automatically escape to ambient air after the turbine is hit.

After some time elapsed, the vapor stream will be purified to contain only working medium and purge all others.

Although open liquid turbine offers benefit to the unwanted gas purging, the side-effect is that it may make a mess by slashing around, especially when the jet stream pressure is too high and the turbine is under-loaded. To prevent from the unwanted splash, a fender should be installed.

If a sealed hydraulic motor replaces waterwheel, no longer need of buffering water tank, then the remains of unwanted gas is better to be purged by vacuuming the system before start; otherwise it will degrade the system performance.

### Ejector Parameters

As to the dimension of ejector, it is highly dependent upon the whole system rating. For the modification to an existing commercial power plant for eliminating the huge evaporator condense tower, the ejector may looks like a monster that an oversized trailer is needed for transportation; for small scale application, probably an insignificant size.

The geometrical parameters of ejector are paramount in importance to system efficiency, though roughly chosen parameter setting may still work. The optimized parameters are always depending on those different applications. Recipe-like parameters configuration is better to be reserved for further protection of the intelligent property as second shield.

More inventions are embedded in different embodiments of derived modalities.

### Invention 2: Stacked Multi-Layer Multi-Effect Integrated Evaporator

Clean energy apparatus based on Wei-II cycle demands the evaporation rate as high as possible. The rate of evaporation is not gained by fossil fuel, but by solar irradiation and/or wind power and/or waste heat and/or ambient background heat and/or other low density of energy input with high efficient stimulation, such as electric or magnetic field.

Obviously increasing the horizontal area of interface surface of liquid and gas can promote the rate of evaporation, because the more area, the more solar energy can be received, then the more vapor produced, but limited land resource often frustrates the area sprawl.

According to common knowledge, the mean solar energy density is about 1000 watts per square meter. Considering 10% conversion efficiency from heat to mechanic work, the estimate value of power density can be circa 100 watts/m² for warm climate.

Compared with the fuel powered embodiments, generally speaking, the clean energy version looks more cumbersome, because of its large land use, and material weight.

As an example, assuming the power rating 1000 W, the evaporation basin or big pan should occupy about 10 square meters.

In order to reduce land use, it is good idea to stack multiple evaporation pans in rack frame.

FIG. 11 illustrates a multiple-layer stacked evaporation-pan rack for saving land use, as well as it also illustrates the use of electric-field boosting the evaporation rate.

A side-effect is that the sunlight can not directly shine on underneath layers except the top layer. This can be addressed by setup adequate mirrors to reflect sunshine.

There is a vapor collect manifold connected to every evaporation layer for vapor output.

The evaporation rate for individual pan may be not equal, so using an N-way branched plumbing hardware to fillup all pans may be not adequate. It is better to control each pan individually.

The space saving is significant. For example, the regular land use of 1000 watts rating is about 10 square meters, but with the stacking evaporation rack of 10 layers or more, may only need 1 square meter.

### Extra Evaporation Boosting Means 1:

An array of cascaded & immersed heat-exchangers or radiators can be pre-deployed as cross-platform interface to couple with other waste heat utilization system, though not drawn in the schematic figure.

### Extra Evaporation Boosting Means 2:

A high voltage (HV) supply module can generate very high voltage depending on the depth of evaporation basin, e.g 15 KV or more. An array of wired electrodes is arranged above liquid surface at a calculated distance. The other electrode plates do cushion the basin or are sunk to bottom of the basin, and all are well grounded for safety. The electrode plate size is better big enough to match the basin bottom area.

The HV module can be powered by adequate battery float-charged by wind turbine in-situ, and then, an inverter is needed to convert DC to AC in adequate hertz (Hz) of frequency.

Just like as the portable USB disk in computer domain, with the modularization of this kind of evaporator, it will facilitate the synergism of different power and generation modalities.

Mathematically the cubic shape occupies less space, so the energy density by volume is the highest. Depending on application location, somewhere maybe horizontally restrained, then the height of this multi-featured evaporator can be greater than horizontal dimensions.

Generally speaking, as this evaporator outputs low temperature vapor that is regarded useless in regular heat engine, so currently it may be only good fit to the ejector-based Wei-II cycle heat engine that can accept large amount low temperature vapor to energize liquid flow.

### Extra Evaporation Boosting Means 3:

Scientific study shows that wind can always significantly quicken the water evaporation. But the sealed evaporation basin sheds off wind totally, so a wind-powered simple stirrer is the alternative way to take advantage of wind power, no matter more or less contribution, better than nothing. The said stirrer is installed co-centrically and immersed under working liquid surfaces.

### Invention 3: The Modalities of Clean Energy Heat Engine Based on Wei-II Cycle.

As aforementioned in the section of “sciences behind the inventions”, a free energy heat engine is possible.

One important derivation is the clean energy modality that converts atmosphere background heat or solar irradiation into useful shaft work.

The saturate vapor pressure does matter for clean energy application, so choosing the right working medium is pretty important to the performance of the expected heat engine.

Low boiling point is just one of the required key criteria. Therefore, the working medium for this clean energy application, should be chosen from those media with adequate saturate vapor pressure commensurate with climate condition, such as aqua ammonia, R123, R236ea, R141b, etc., or their mix, Water may be only adequate for use in summer.

Other factors, such as safety aspect, flammable aspect, etc. should also be considered with the decision of working medium.

If high freezing point working medium selected, such as water, then anti-freezer fluid may be needed during winter time. And the anti-freezer may change the thermo-physic properties of the principle working medium, so it should be considered if happens.

For absorbing as much solar energy as possible, black dyeing can be doped as additive with working medium, as long as the dyeing does not restrain the evaporation.

A derived modality of such a clean energy heat engine is drawn in FIG. 5.

It comprises an ejector, evaporation basin, open buffering tank, power turbine, pump as starter, heat exchanger, check valve, control valve, wind-powered stirrer.

The evaporation basin is airtight and transparent. In working stable state, the basin may be in quasi-vacuum condition, as the vaporized gas is constantly sucked to the induct inlet of ejector.

Because air is not soluble in water or most liquid, it can cause cavitation side-effect inside the ejector or when hitting turbine, so it is better to get rid of it. However air is always inevitable during the very beginning running time, luckily it will be automatically bled off later, as the remaining air will escape from the open buffering tank when discharged flow turns the turbine.

The transparent cover of the basin is good for receiving solar irradiation energy. And, because of the inner quasi-vacuum, the cover may suffer from great atmosphere pressure, so an array of well distributed undercover pillars may be needed to strengthen the structure depending on the basin size.

This clean energy heat engine does need a starter to kick off, because it can not automatically intake liquid from the open buffering tank before stable state has been established. After started, the evaporation basin inner quasi-vacuum will be looming, and then, the intake flow of ejector can be driven and sustained in relay of the bypass check valve by atmosphere pressure at the source end of the open buffering tank.

With the ongoing of evaporation process, the liquid level inside the sealed basin will be lowered down, as well as increase up the level of the open buffering tank underneath the turbine. So controlling the level is necessary. This can be done by a controlled solenoid valve that connects the basin and the open buffering tank. The liquid transfer is naturally powered by atmosphere pressure, only a little bit of control signal energy will be used.

The powerful turbine can drive electric generator to power other electric units, and the self-governing control circuit, though directly make use of the shaft work also feasible.

FIG. 6 shows a derived modality with electric-field booster. It is almost the same one with FIG. 5, except the extra electric-field stimulation sub-system.

A special series of varieties is worthy to mention: It is featured that the waterwheel turbine is not driven by the jet flow out of ejector portal, but by pressurized liquid outflow of container. And from the pressure-augmented discharge portal of ejector, working liquid is fed back to the pressurized container, so as to maintain the pressure therein.

FIG. 9 shows a clean energy engine with turbine driven by flow of ballasted liquid in a tank.

It comprises a pressurized liquid cylinder, pressurizing heavy weight ballast over the top of the said cylinder, turbine, ejector, open buffering tank, sealed transparent evaporation basin, starter pump, heat exchanger, high voltage supply, wind-powered stirrer, and some valves.

When open the manual valve near the bottom of the pressurized cylinder, the liquid will rush out at a certain velocity, and then the said turbine turns to output mechanic work.

The velocity V of the jet stream toward turbine is dependent on the cylinder pressure, or accurately, the pressure difference P1−P0 of absolute pressure P1 of cylinder and the atmosphere pressure P0=1 atm or 1 bar.

Velocity V=14*\sqrt{P1−P0}(m/s)

If P1=2 atm, then V=14 m/s.

Initially the pressure P1 can be set by heavy weight ballast over the piston of the cylinder. When the liquid flows out some volume Vol, P1 will decrease.

Only by returning same amount Vol of liquid from other port, can the P1 be maintained constant. This can be implemented by discharging liquid from the well designed ejector in augmented pressure P2 than P1 in order to overcome the resistance of the P1.

After started, the motive flow of the ejector is 1 atm liquid from the open buffering tank, the induction flow is from the quasi-vacuum (assume pressure P3) upper outlet port of the evaporation basin. When 2 fluid streams mix in supersonic shockwave state, the ejector discharge portal will generate increased pressure P2, as well as higher temperature liquid.

Only a low percentage of vapor latent is converted into liquid kinetics, most is used for increasing temperature. By using a heat exchanger, the internal-energy-increased liquid can return heat to liquid inside evaporation basin, and then quicken the evaporation rate.

All pressures of different points match this expression: P2>P1>P0>P3.

If the motive liquid pressure P0 of the ejector not big enough to generate decent P2, boosting P0 by adequate percentage may be necessary. So in this situation, the starter pump can be replaced with a permanent duty boosting pump and powered by the turbine via transmission.

Because P0 1 atm>P3 quasi-vacuum, so transfer liquid from the open buffering tank to the evaporation basin is easy, only a low energy consuming solenoid valve can cope with the level governing.

The transparent evaporation basin, the stirrer, and the electric-field stimulation sub-system, all those work in the same rationale as in FIG. 6, described in upper context.

If not want to be bothered by the sealing problem of ballasted pressurized liquid tank or container, just rise a high liquid column to get the same bottom pressure by natural gravity.

FIG. 10 shows a clean energy engine with turbine driven by flow from high-rise water column.

As 10 meters high water column is equivalent to 1 atmosphere pressure. So for water working medium, and if bottom P1=2 atm absolute pressure is required, it is OK to erect a 10 m height water column. Just make sure the column top is open, because the atmosphere is needed to add to the absolute pressure P1.

### Desalination Variety: Co-Generation of Power and Freshwater by Desalination

It is well known that all existing desalination system will consume energy more or less. Is there any special desalination system with not only zero or almost zero energy consumption but also power generation simultaneously?

The answer is YES. By making small change to previous inventions, such a special desalination system can be formed.

There are 2 schematic drawings illustrating the power+freshwater co-generation system.

FIG. 6a shows a clean energy engine with seawater-to-freshwater production based-on FIG. 6.

FIG. 9a shows a clean energy engine with seawater-to-freshwater production based on FIG. 9.

The fundamental freshwater is needed to start the whole system, so that initial freshwater can be regarded as seed freshwater. For sustainable running, controlling the buffering tank level is necessary, and it can be done by removing the generated freshwater from the turbine loop by gravity or whatever means to outside pool or tower.

Generally speaking, this clean energy version desalination modality is good for bulk freshwater production, because free energy not powerful enough for massive scale.

The salt concentration in the evaporation basin or tank can be very high even without limitation, in contrast, the nowadays osmosis method needs to drain off the seawater if reaching a little bit high salt concentration, and that makes less sense of economics.

### Invention 4: The Modalities of External Combustion Heat Engine Based on Wei-II Cycle.

The famous Stirling style heat engine is just the type of external combustion; however it has never been popularly used, because of its low efficiency and other demerits.

New style external combustion engine is possible to make some varieties based on the aforementioned inventions with minor almost zero modification, just simply use fossil fuel.

FIG. 8 shows a possible external combustion engine utilizing low pressure hydraulic, though the low pressure & high flow rate motor is hard to procure in current market and nowhere to bleed the insoluble gas, so then its feasibility is still in question.

FIG. 12 shows a compact fueled engine with waterwheel turbine driven by flow of ballasted liquid.

Compared with the clean energy version, this modality makes some parameters significantly changed.

Firstly, because of high energy density of combustion, the large scale evaporation basin can be replaced with compact boiler, and the upper vapor space no longer quasi-vacuum, can the vapor pressure P3 easily be higher than atmosphere P0, even reach the cylinder's pressure P1 before the ejector pressure augmentation effect is exerted.

The new scales of pressures now follow new expression: P2>P3>P1>P0.

Secondly, Because of P3>P0, transfer liquid from the open buffering tank to the boiler does need a powered pump, not a simple controlled solenoid valve.

But no worries about the energy consumption of the transfer pump, unlike compressing compressible gas, pumping non-compressible liquid will just consume a few of energy.

Thirdly, the motive fluid no longer liquid, but it is strong steam, and the liquid in the open buffering tank is to be sucked to the ejector because of relative negative pressure. This will also cause the reduction of ejector size.

Fourthly, immersing the heat exchanger in the open buffering tank may be better than inside the boiler, though it is still drawn there in the FIG. 12.

Fifthly, the starter pump is no longer needed. The external combustion can start system.

For most space/weight restrained applications, this modality may be the best choice as a feasible external combustion heat engine, though not clean energy technology.

Generally speaking, in such an application of external combustion engine, the temperature is significant high inside boiler, so is the vapor pressure.

The best working medium for such modality is water, it is cheap and accessible anywhere.

### Powerplant Variety: Exhaust Vapor Recycled by Wei-II Cycle Second Generator

The regular power plant always has an array of cooling towers in jumble skyscraper size for condensing exhaust steam or most simply be dumped while condensation rate lagging behind the turbine discharging rate.

By feeding the exhaust steam into a Wei-II heat engine, a secondary power station can be built in economic way.

FIG. 13 shows a simple Wei-II cycle modification to regular power-plant with 2^{nd} generator.

By consuming a fraction of new generated energy in the water pump that is inlined in the waterwheel turbine loop, most exhaust water can be reclaimed to the main power generation system.

The motive liquid flow comes from the boiler, and its pressure is higher than the intake exhaust vapor fed in the induction inlet of the ejector, then the vapor latent heat is absorbed, and the more powerful jet stream strikes the waterwheel turning. The secondary electric generator driven by the waterwheel turbine will output hydro-energy that can be used locally in partial and combined to the main grid-line.

If omitting the key component waterwheel turbine, the simplest modification to existing powerplant could be done as illustrated in FIG. 13a.

The biggest disadvantage is the pressure of ejector outlet P2 is too far greater than inlet pressure P1, and nowhere to release the kinetic energy, but to impact the boiler inner wall and space, cause great agitation of tidal wave just like as tsunami. Great noise or water hammer effect also may occur.

Not only above demerits, but also the water pump need consume some energy, though it is not significant because the liquid water is not compressible.

In this simplest invention, the position of water return inlet of boiler features underneath water level to increase viscosity for inhibiting water hammer effect, and the liquid-liquid friction can also heat the boiler in a mechanical way, so fuel cost can be saved in certain limited extent.

Other remedy is to use waterwheel turbine to absorb the kinetic energy then let P2 slightly great than the inlet pressure P1. Usually let P2=P1*110% can be enough to overcome the back pressure for smooth return of water.

Whether to keep the original evaporator and pump may be optional.

By feeding the exhaust vapor as motive flow, there exists another variety modality that is showed in FIG. 14: A simple Wei-II cycle modification to regular power-plant with the 2^{nd} generator.

In that variety, additional open buffering pool may be needed. Not only the liquid water can be siphoned from the said pool, but also can it be pumped through a boosting pump for better performance tuning.

It is also possible to combine the said pool with the open buffering tank under the waterwheel into a single big pool; otherwise, a gravity driven pipe is needed to balance the levels of both containers.

In both of the FIGS. 13 and 14 modalities, the position of water return inlet of boiler features above water level to decrease viscosity for saving energy consumption of water pump, further they need carefully control the liquid level of buffering tank or open pool, and it can be governed by a control module with input of level sensors.

### Desalination Variety: Co-Generation of Power and Freshwater

FIG. 12a shows a power plant with parasitic desalination freshwater plant based on FIG. 12.

The principle of energy and heat generation is described in those respective base figures. As to the new varieties, the common variance is to isolate sea water and fresh water, as well as the evaporation distillate the freshwater out of salt water into vapor, then the vapor is condensed in the ejector while power and heat energy are co-generated.

This modality is good for large scale freshwater production, as well as the aforementioned free energy version is good for bulk production.

### Vacuuming Variety: Co-Generation of Power and Vacuuming Capacity

Currently, the Venturi jet steam vacuum system, such as the famous GEA series products, are commonly used in petroleum refinery industry, though there is significant waste heat generated.

By modifying some of previous modalities, the vacuuming capacity can be obtained.

FIG. 12b shows a power plant with vacuum co-generation capacity based on FIG. 12, and this modality also falls in category of external combustion engine application.

In this variety, another ejector is inserted in the turbine loop, and that means a plurality of ejectors can be catenated in a series with different assigned function.

The vacuum-objective vessel initially is full of air or other gases at 1 atm pressure, and caused by Venturi effect, the inner gases will be gradually evacuated. So during the initial stage, high proportion of insoluble gases such as N₂ and O₂ are mixed inside the turbine loop, and will escape quickly while fluid hits the turbine.

Because insoluble gas can result in low efficiency of working ejector power output, only after entering vacuum maintaining stage that the preset low vacuum pressure is reached, then the power efficiency rises to normal stable status.

In fact, the inserted vacuum ejector is flexible for the position of segment, as long as there is strong liquid flow.

Good sealing of the vacuum vessel can help improving the efficiency of shaft work output.

In industrial application, the generated power and heat can be used for support of local refinery processes or any local requirement.

### Invention 5: Flue Gas Heat Reclaimed Modality of Ejector Based Wei-II Cycle Heat Engine

The hot flue gas is also called exhaust gas, and it is consisted of multiple ingredients:

CO₂+H₂O+NOₓ+N₂+O₂+SO₂.

Not only is there significant sensible heat in flue gas, but also large proportion of latent heat hidden in water vapor.

In thermophysics, when dealing with the heat of combustion, there are 2 concepts: one is the higher heating value HHV, the other is the lower heating value LHV. Typically there is 10% difference between HHV and LHV, that percentage is just the proportion of the latent heat in the combustion water vapor.

So even only reclaiming the water vapor latent heat in flue gas, it will increase the system efficiency about 10%.

Depending on the type of fuel, some fuels, such as coal, its combustion flue gas can contain high concentration of sulfur that is the culprit of acid rain; and all fossil fuels' flue gas contain more or less nitrogen x-oxide toxic gas.

Both SO₂ and NOₓ are easy to be absorbed by water in a way of chemical reaction to product acid, as well as great thermal energy will be released, as a reward, this may also increase the system efficiency by additional small percentage if reaction heat reclaimed.

By introducing the flue gas to ejector-based heat engine, not only the water vapor latent heat can be reclaimed, but also the greater chemical reaction thermal energy joined serendipitously, as well as the acid by-product can be harvested. More importantly, it can reduce pollution and diminish greenhouses side-effect, and improve human being living environment at last.

FIG. 15 shows Wei-II cycle stage to claim water vapor in flue gas, and de-NOx & de-SO2 simultaneously.

Because of lots of acid products are synthesized, all wetted parts should be anti-erosion to acid in this diagram for long service time.

The buffering tank under the turbine should be hooded in order to collect and conduct the remaining gas that is still enriched of carbon dioxide for next sequestration process.

As the pressure of flue gas is just the same with atmosphere, so it is not good to use it as motive flow, instead a booster pump should be used to draw water with proper pressure from the open pool.

The anti-erosive-material-made turbine can drive another electric generator, though quite a proportion of the generated power may be consumed by the said booster pump to cope with heavy-duty process of massive flue gas emission.

The produced nitric acid and sulfur acid are mixed together in the buffering tank and the open pool. Although diluted in large volume water in early progress, with the running time lasting, the acid concentration will get higher and higher eventually.

For absorption performance, when the aqua acid approaches a preset threshold concentration, the transfer pump should take out the products liquid to dedicated storage tank, as well as fresh water should fill up the open pool in proportion.

According to the description in the previous section of “Sciences behind the inventions”, the different components in flue gas take different proportion by mass ratio as follows (for gasoline fuel):
CO₂: 19.2%, H₂O: 8.8%, N₂: 71%.

That means 1 kg flue gas can produce approximately 0.1 kg water. Considering the SO₂ and NOₓ take very small ratio in mass of flue gas, then the absorption chemical reaction will not consume much of the new produced water, so that, more and more water will be accumulated in long time running.

But for starting the absorption process, it is still necessary to prepare adequate initial water in the open pool; hence, those fundamental water can be regarded as starting water.

As an option, the open pool can be combined together with the buffering tank under the turbine into a single hooded tank, as well as some control parameters may need tune-up.

The new generated liquid water from flue gas can not be fed into the boiler to compensate water loss in the main cycle, because it is acid and harmful to boiler structure, unless it is distilled from the mixed solution.

Therefore, also the quickly accumulated heat in this modality can not offer benefit to the main boiler fuel reduction, hence co-generation of power and heat is a better choice, so prior to shoot turbine, output of heat energy can be done by routing the hot jet flow via radiator-network of distributed heat exchangers where heat supply is demanded.

If a parasitic acid production line is built, extra energy or heat is needed for separation of nitric acid and sulfur acid, then for purification. The aforementioned heat output may cover all the this local heat demand, as well as the intrinsic turbine generated energy may be not enough to cover all other processes, so borrowing energy from the main turbine may be necessary. Anyhow, this is not in scope of subject inventions.

Regretfully the carbon dioxide is not easy to be absorbed by water; however it can be fixed in other way that will be described in following paragraphs.

### Invention 6: CO₂ Sequestration Modalities of Ejector Based Wei-II Cycle Heat Engine

Carbon dioxide is officially regarded as the root causer of global warming despite of controversial in the academic circle.

Since Montreal protocol born, many countries make incentive policies to attract industrial communities taking action to gradually reduce the carbon emission.

As aforementioned, about 19.2% of flue gas mass is the carbon dioxide, and 1 kwh electricity production may emit up to 1 kg CO₂. So it is an enormous harsh task to sequestrate CO₂ in a large scale fossil fuel power plant.

Traditionally the cheap lime is used for carbon fixation from flue gas. Herein, a new modality is introduced by using the same material but with mechanic work output simultaneously through the reclamation of chemical reaction thermal energy.

FIG. 16 shows Wei-II cycle stage to sequestrate carbon from flue gas by lime.

Basically its mainframe there exhibits no big difference with previous relevant modality, the kernel parts is still an ejector, but lime is used to sequestrate carbon from the flue gas that is already dewatered and desulfurization and de-nitrated in previous stage of process, but still with rich carbon dioxide.

A lime storage hopper is set above the open pool where lime power is mixed with water to form limewater emulsion. Because of the property of the low solubility of lime, an agitator is used to stir the ‘soup’ into emulsion state.

The reaction equation is:

Ca(OH)₂+CO₂=CaCO₃↓+H₂O.

The symbol ↓ means insoluble in water, so sediment will be seen.

If surplus CO₂ is supplied, a co-existing reaction with better solubility resultant may happen:

CaCO₃+H₂O+CO₂→Ca(HCO₃)₂

By well controlling the CO₂ input rate, the above reaction can be depressed.

The ejector provides an intrinsic fluidized reaction condition, and the exothermic energy does power the product calcium carbonate jet flow to turn around the turbine that will drive another electric generator.

Because the product calcium carbonate is not soluble in water, so it will precipitate to bottom of the buffering tank under the turbine. So, separation is not difficult.

As new water is produced in this reaction, and just flooding on the deposit of product calcium carbonate, so it can be recycled for making hydrated lime emulsion by conducting the top water to the open pool via gravity pipe.

Although most of nitrogen and sulfur related gas can be absorbed in the same time of reclaiming the combustion water vapor, still some residues of NOₓ and SO₂ may exist after the previous absorption process, herein, they can be sequestrated by calcium hydroxide:

SO₂(g)+Ca(OH)₂(s)+H₂O(I)→CaSO₃(s)·½H₂O+3/2 H₂O(g)

The calcium sulfite CaSO₃ is produced in the further process of flue gas desulfurization (FGD).

Calcium sulfite is relatively worthless though, because it has very few uses. It can, however, be oxidized to produce gypsum or calcium sulfate dihydrate CaH₄O₆S, which can be used commercially. This oxidation reaction is the reason it is not stable in things like drywall, as it uses water and oxygen, common conditions in the Earth's atmosphere.

The generated power by this ejector-based carbon sequestrating reaction can offset the lime cost in a certain extent, plus the auxiliary energy consumption, such as agitators or so, and in contrast, the product calcium carbonate almost little or no value. But the positive balance and benefit may not be commercially high, so the motivation of using such a carbon fixing method may not be high impulsive enough. Luckily most governments all over the world will subsidize such a promising investment.

The chemical-reaction-generated heat is another significant energy source available for output, but the raw quality is yet in low grade, compared with main boiler in situ. Therefore, the accumulated heat in this modality can not directly contribute to the main boiler fuel reduction unless lifted by heat pump, hence co-generation of power and heat is feasible, so prior to hit turbine, output of heat energy can be done by routing the hot jet flow via array of distributed heat exchangers where low grade heat supply is demanded.

Another variety of this kind of modality will be introduced in feature of producing high value-added product, in favor of investor's lucrative avid motivation.

Value-Added Variety: Parasitic Soda Factory with Both Carbon Sequestration and Power Generation

The Solvay process or ammonia-soda process is surely the major industrial process for the production of sodium carbonate (soda ash). This process was developed into its modern form by Ernest Solvay during the 1860s. Its ingredients are readily available and inexpensive: salt brine—NaCl and limestone—CaCO₃.

Because of plenty of carbon dioxide supply available from flue gas, it seems no longer necessary to calcine limestone by providing extra energy in pyrolysis process in purpose of producing CO₂, instead lime—Ca(OH)₂ is used here. Further instead of dedicated chemical reactor, ejectors are used and power generation is also targeted, so the whole process is just a quasi Solvay process.

The generated power and heat can cover the energy demand at least for converting the intermediate product—baking soda into regular soda.

Just like as the genuine Solvay process, the use of ammonia herein is almost conservative, only small fraction supply is needed for compensating the minor loss.

Not only the product soda is commodity, but also the other product—calcium chloride CaCl₂ is useful and valuable as de-icing material for road maintenance in winter.

So, in a sense, this modality looks like a dual products parasitic factory with power and heat generation as well as benefit-profound carbon sequestration.

FIG. 17 shows the Wei-II cycle stage to sequestrate carbon from flue gas by quasi Solvay process.

The 2 basic reactants salt and lime need massive supply for sustainable soda production, also as the raw solid phase should be converted to phase of liquid solution by mixing with water for quick and convenient reaction, so that, 2 raw material hoppers are hanged above respective solution preparation tank or pool, as well as agitators are immersed in all solution containers for uniform mixture.

The open pool is used for preparation of saturated salt water solution, as well as, a sealed and hooded solution tank under the lime hopper is used for regeneration of ammonia vapor. The latter tank is also referred as ammonia regeneration tank.

There are 2 ejectors in tandem in this modality, labeled as 3^{rd} ejector and 4^{th} ejector.

The 4^{th} ejector receives the motive flow driven by the booster pump that draw salt solution from the open pool, and while the said motive flow rushing inside the ejector, the induced negative pressure in the suction inlet will intake ammonia vapor from the ammonia tank that functions as buffering container and bridges the regeneration tank and this ejector. Then, because of great deal of released heat while ammonia vapor dissolves in water, the resulted shockwave will empower the jet flow at the outlet port.

In next episode, the power-added jet flow generated by the 4^{th} ejector will be fed to the 3^{rd} ejector′ motive flow inlet. Of course, this input flow contains hot solution of salt and ammonium, and the rushing motive flow will induce the intake of flue gas that is enriched with CO₂ after previous processes where H₂O vapor & NOₓ & SO₂ are likely removed. Just in the fluidized shockwave area of the 3^{rd} ejector mixing chamber, the typical reaction of Solvay process will happen:

2NaCl+2NH₃+H₂O+CO₂→Na₂CO₃+2NH₄Cl

Following reaction also possible if surplus CO₂ is over supplied & temperature is mild.

NaCl+NH₃+H₂O+CO₂→NaHCO₃+NH₄Cl

Not like Na₂CO₃, the resultant NaHCO₃, i.e. baking soda or sodium bicarbonate, is not the designed last product, but easy to get the desired soda by heating baking soda elsewhere.

Optimistically the shockwave reaction area is very hot, so that, the baking soda resultant is hard to exist because of the respective reaction is depressed, though some trace residue may still remains.

Compared with the other by-product NH₄Cl ammonium chloride, the solubility of soda is far less. This property can be used to separate the 2 compounds by a filter or other cheap means. Anyway, it is not the focus of the subject invention, so the separation module is only drawn as a black box in the subject figure—FIG. 17.

If the separation module or other local units needs heat supply, the strongest and hottest jet flow of the 3^{rd} ejector can be routed through a heat exchanger to satisfy it, then punch the waterwheel turbine to output mechanic work; otherwise it directly hits the said turbine for power generation.

Compared with the aforementioned two modalities for existing power plant modification, only this modality generates more dense heat, because the reaction heat per mole captured CO₂ is the highest amongst the series modification modalities.

The generated reaction heat is also important energy source available for output; hence co-generation of power and heat is feasible. By routing the hot jet flow from ejector outlet to where heat supply is demanded by individual radiator, prior to let it hit turbine, the heat energy can be well utilized locally or output.

The aforementioned Invention 2: stacked multi-layer multi-effect integrated evaporator, can take the heat output of this modality for improved performance in its related application. As illustrated in FIG. 11, the stack style evaporator can be equipped with immersed heat-exchanger array for external coupling.

Because large amount of nitrogen gas N₂ is mixed in the flue gas, and it can not be fixed in any aforementioned process, so that, the escaped gas around the rotating turbine should be conducted to emission tower and released to sky atmosphere.

As to the by-product NH₄Cl, it can be buffered in a tank connected with the separation module, then feed the ammonia regeneration tank where it reacts with lime & regenerate ammonia vapor which is collected to nearby ammonia tank, as well as another product calcium chloride CaCl₂ is produced.

As the NH₃ regeneration reaction is endothermic, so that, external heat energy should be supplied. Following is the reaction equation:

Ca(OH)₂+2NH₄Cl→CaCl₂+2NH₃+2H₂O(ΔH=91kj, endothermic)

The external heat can be supplied by heat exchanger immersed in the regeneration tank. The hot jet flow of the 3^{rd} ejector can be directly routed herein or indirectly via heat pump worked on other isolated fluid medium to supply higher temperature.

Although the ideal reaction should be as fast as a flash because the herein special reaction device is just an ejector where all elements are moving forward and not allowed time-consuming lingering, however the real world may be always a little distance to the idealism, that may result incomplete reaction in the straightforward one pass-through.

As a remedy, either by elongating the ejector and pipes or re-circulating more times of stale stream rather than one pass-through, both are acceptable as long as synchronization not seriously affected even with compromise of small amount of CO₂ free of process. However, if one pass-through can achieve very high ratio of resultants to reactants, and reach a preset threshold, then, for economic consideration, no remedy may be necessary.

Such an idea with proper sensors and transducers and executing devices, is not illustrated in the schematic figures.

Power (bundled with heat) generation and soda production are the dual key interested points of this modality. The generated electricity power can cover the local use of appliances, such as the agitators, material handling, control system, etc., and the prime portion is then to feed in the main grid power line. That eventually increases the total energy generation efficiency of the modified power plant.

The products soda and calcium chloride are lucrative commodities, so the commercial return is great enough to cover all the raw cheap material input: salt and lime.

The USPTO published a patent application 20100196244 A1—“Method and device for binding gaseous CO₂ to sea water for the flue gas treatment with sodium carbonate compounds” which priority date is Mar. 15, 2007, it is the closest invention that uses same quasi Solvay method to capture CO₂ from flue gas, but however, herein invention focuses energy self-supply and multiple functions simultaneously.

### Invention 7: Immersed Internal Combustion Engine Based on Wei-II Cycle

Until this paragraph, all aforementioned modalities have non-fuel working fluid involved.

Now a new variety will be introduced with the feature of fuel as one of the multiple working fluid media.

Usually such a combination of three media is OK: one is fuel, the other is water, and the last is the omnipresent air. Of course, the air provides oxygen for fuel combustion, and should be doped with fuel vapor in good proportion for complete combustion.

FIG. 18 shows an ejector working in condition of immersed internal combustion.

Generally speaking, fuel substance is not soluble in water, so formation of cavitation bubbles is very easy inside ejector.

Instead of solely latent heat of flash condensation triggering shockwave inside ejector, this variety of modality will exhibit more powerful shockwave detonated by internal combustion inside all compressed cavitation bubbles those are individually capsulated with high temperature mixture of fuel and air, and averagely clustered in a cloud-like dense zone.

Just like as a regular diesel engine without electric ignition, the intra-cavitation combustion can be ignited by itself internal high temperature caused by extreme compression.

The outer wall of shockwave segment of ejector can be wrapped with ultrasonic vibration conic socket to induce and improve shockwave strength.

Luckily not like as the regular internal combustion engine, there is no need of complicated timing ignition at all.

More interestedly, the resultant H₂O of the said combustion can be condensed into liquid water instantly with the simultaneous and spontaneous utilization of the latent heat, though the CO₂ still regrettably exists in gaseous phase. Even only by this, about 10% usage of fuel heat value extra is utilized than the regular internal combustion engine.

In a sense, the said combustion is flameless, because the size of cavitation bubbles are so tiny and immersed in water. That is why it also named as immersed flameless internal combustion engine.

Of course, the energy density is comparable with the regular internal combustion engine, so there is potential to apply it as vehicle power supply.

If the driven load is too heavy duty to stall this kind of engine, there will be a spasm of reverse flow inside the ejector prior to stop.

As a common demerit, the cavitation effect of resultant CO₂ of combustion may deteriorate both ejector and the vanes of waterwheel turbine, because it is hard to be absorbed by water. Some means can be done for mitigation though inevitable, e.g. using better material.

FIG. 19 shows an immersed internal combustion engine based on Wei-II cycle.

It roughly looks like no big difference with all other Wei-II cycle ejector-based heat engines, but this modality does feature that the mixture of oxygen or air and fuel vapor is inducted into ejector by motive flow of uninflammable liquid (e.g. water) then combustion bursts inside shockwave segment of ejector because of high temperature self-ignition caused by high compression of cavitation.

It comprising a Venturi mixer, an ejector, a waterwheel turbine, a carburetor, fuel tank, fuel pump, water hydraulic pump, hooded buffering tank, exhaust pipe and muffler, evaporation boosting heat exchanger, cab heater and fan-forced radiator, evaporation boosting ultrasonic actuator, evaporation boosting electric field module, overflow water drainage, transmission, alternator, starter, battery.

The Venturi mixer is used for mixing air and fuel with adjustable choke & throttle control, and its outlet is hooked to the power generating ejector.

The motive flow is provided by a water hydraulic pump which fluid medium can be water and working pressure is close to the same order with regular oil hydraulic pump. The driving power of the said water hydraulic pump comes from the system main torque PTO (Power Take Off) shaft with flywheel that can accumulate adequate momentum of inertia for sustainable operation.

As to the waterwheel turbine, it is just the system power root provider, and is also coupled with the said system flywheel.

Because the intra-cavitation combustion results in huge shockwave power, the ejector outlet pressure is far greater than the motive flow pressure, so that, the generated power is far greater than the driving power of the water hydraulic pump, and great positive balance of power can be used to drive the power-train that drives vehicle running eventually.

Fuel can be gasoline, diesel, kerosene, biogas, or whatsoever liquid fuel, as long as it is easy of evaporation and can be safely controlled. Such an engine even could be adaptive to all available main stream liquid fossil fuels without significant modification.

As to the undrawn starter, it is also coupled with turbine flywheel shaft, and can be the kind of regular automotive starter, but possible less electric power rating because of light duty of start-driving the water hydraulic pump.

The evaporation can be boosted by ultrasonic generator and electric field (not drawn), and all of them are powered by the alternator that is also charging the battery and supplies other auxiliary consumption.

According the aforementioned calculation, if the fuel is gasoline, then there will produce about 0.46 kg water for every 1 kg emission of carbon dioxide.

Most generated water will be absorbed and drained while the buffering tank overflows, and so does the NOx. However, small portion of escaped water vapor and nitrogen x-oxide may be still mixed with carbon dioxide in the exhaust gases, and the exhaust is highly concentrated of CO₂ in principle.

Boosting evaporation of fuel can also be aided by heating the liquid fuel in the carburetor, as plenty heat energy will be generated in circulating water, so it is easy to implement by routing the hot jet flow through a buried heat exchanger inside the carburetor.

Heating the fuel will not consume much of generated thermal energy, and too hot water will degrade the engine efficiency even cause heat stress, so a forced cooling radiator is necessary to dissipate surplus heat in the engine block.

A cooling radiator is usually installed at front grill of vehicle and perpendicular to the main power shaft, as well as a fan is blowing the radiator while running.

For cab climate control, the surplus heat will also be dissipated to the cab space via cab heater radiator.

To cope with the risk of freezing in winter, anti-freezing liquid should be added to the circulating water in a proper proportion to tune-up the desired freezing point temperature. The anti-freezer should not dissolve fuel, such as ethylene glycol; otherwise the power performance will be degraded.

Nowadays gasoline may contain up to 10% ethanol, and the ethanol is soluble in ethylene glycol, so the anti-freezer ethylene glycol may be not good match with the gasoline doped with ethanol.

Although a car symbol can be seen in the corresponding FIG. 18, it doesn't restrain where the embodiment can be used, and in fact, it can be utilized anywhere provided high energy density power output is demanding, no matter stationary or mobile application.

An Important Variety of Such an Engine with Simultaneous Ammonia Synthesis Production

The industrial method to produce ammonia is by the famous Haber process with extreme pressure and temperature, i.e. circa 2200 to 3600 psi, and 400 to 500° C. that is high energy consuming process though stoichemically it is an exothermic reaction:

N₂+3H₂ [symbol] 2NH₃ (ΔH=−92.4 kJ·mol⁻¹)

In general sense, the above reaction can be regarded as a special kind of combustion without visible flame.

The balanced equation of the synthesis, again, deceptively looks simple, but the energy of dissociation of triple covalent bond of nitrogen molecule N≡N is as high as 9.76 eV, so even 2 Nobel prizes have been awarded for the inventions of ammonia synthesis, mankind is still struggling with its high energy consumption and low production rate.

The ammonia synthesis is a process that every single one of us has benefited from directly or indirectly, whether we know it or not. In fact, it has become one of the most studied reactions in history, also its intricacies and complexities are the subject of several textbooks, and its legend history is a complex tale of good and evil.

FIG. 20 presents an immersed combustion engine with ammonia synthesis production; it is a revolutionary invention to overcome the shortcomings of Haber process: no loner energy guzzler, but becomes energy producer with the import commodity ammonia as the useful by-product.

No big variance with the foregoing liquid fuel version unless specially remarked herein, basically just omitting the carburetor, and using hydrogen H₂ as the fuel, as well as the ultraviolet (UV) and/or High Voltage immersed gas Discharge (HVD) module can play importance role to break dual atom gas molecule, especial the tough strong 3 covalent bonds N₂, into reaction-ready single atom gas, so as to facilitate the ammonia synthesis.

The fitting tube behind the gas mixer should either UV-transparent or sandwich the inner UV lamp; further a recycling gas circuit is employed to reuse the remains gas of reactions.

Although only partial N₂ is converted into single atom by UV radiation, it does facilitate the oncoming caviation ignition. As long as the reaction triggered inside ejector, the generated heat plus the compression heat then teamwork altogether to break more N₂ into single atom or ion inside micro capsulated bubbles.

Because 1 molecule of dual atom gas is to be broken down to 2 molecules of single atom, then the occupied volume will tend to be doubled, so that, the tube conduit that is under influence of the said UV or HVD dual-to-single-atom molecular cracker is better in the shape of flare toward the flow direction.

For an eximer 126 nm UV lamp its photon energy 9.8 eV, it is enough to break the nitrogen molecules, so such an UV generator can be considerable.

UV light is also referred to vacuum ultraviolet because of the regular origination from the HVD in vacuum tube. So technically the UV effect is equivalent to directly use the HVD by inserting arc discharge electrodes inside the said gas inflow tube, as long as the discharge energy of high voltage electric field is on par with the UV photon.

As per convenience condition, even both means of HVD and UV modules can be used, though either the combination or HVD module not drawn in the said FIG. 20.

It is physically impossible and unnecessary to complete break all molecules passing through the gas inflow tube conduit, because of either fast flow short time or not economic.

In fact, a minor percentage of dissociated single atoms as detonator can start the chained combustion reactions inside the cavitation cloud in ejector.

As to the original fuel mixer, it was recommended to use a Venturi tube because of the low vapor pressure of gasoline or the likes, but the herein variety modality may use high pressure hydrogen supply bottle, so more choice for the mixer, even as simple as the regular 3-way hardware fitting.

If not pure N₂ but regular air used, the oxygen will also react with hydrogen to burn into water. Although the said oxygen combustion is dangerous in traditional Haber process because disastrous explosion may be detonated in reaction vessel, luckily herein it does contribute complementary heat to break the tough nitrogen covalent bonds while as contributing extra kinetic power to the output jet flow without worry of ejector explosion.

Other minor benefit for the air inflow is the reduction of water supply because oxygen combustion will produce water and be accumulated in the buffering tank.

Following more completed reactions can occur simultaneously inside caviation bubbles.

N(g)+3H(g) [symbol] NH₃(g→l) or 3N₂(g)+3H₂(g) [symbol] 2NH₃(g→l)

O(g)+2H(g)=H₂O(g→l) or O₂(g)+2H₂(g)=2H₂O(g→l)

O+N [symbol] NO or O₂+N₂ [symbol] 2NO

NO+O [symbol] NO₂ or 2NO+O₂ [symbol] 2NO₂

NO₂+H₂O [symbol] HNO₃

NH₃H₂O(aq)+HNO₃(aq) [symbol] NH₄NO₃(aq)+H₂O(l)

The “g→l” means first gas explosion, then quickly liquid implosion because of flash condensation caused by the generated high temperature vapor meets the low temperature water inner wall. Also the single atom-involved reaction can empower and trigger the dual-atom-involved reaction in the chain style.

So if air is used, the buffering tank probably contains the soup of NH₃+HNO₃+NH₄NO₃, then separation work should be done to produce individual pure compound. Of course, for good quality ammonia product, it is recommended to use pure nitrogen as inflow.

The alternator can empower the ultraviolet generator, high voltage immersed gas discharge module, ultrasonic generator, and other auxiliary appliances.

The inflow fuel H₂ may not be totally combusted inside ejector, though existing second chance on cavitation bubbles hitting turbine surface to trigger another micro combustion, whatever remains of unused H₂ and N₂ will be collected inside the sealed and hooded buffering tank and re-conducted to the suction inlet of the ejector by feedback pipeline.

Just like the Haber process, the ferrous metal or associated compound can quicken the ammonia synthesis, so as herein this modality, tiny particle iron powder can be mixed with water in emulsive state to function as catalyst and nucleater for easy cavitation bubble formation. Associatedly, if any catalyst material used, the product transfer from the buffering tank should filter the catalyst particles to prevent unnecessary catalyst loss.

The converted electricity by the turbine shaft work, can be optionally used to electrolyze water to generate H₂ as a supplement to the main hydrogen supply source so as to reduce the net outsource input but reduce the available shaft work output simultaneously, however never possible to replace totally the outsource H₂ supply because of the energy conservation law.

The topology in FIG. 20 can embrace lots of similar variant modalities with purpose of synthesis other than ammonia, as long as the resultant is soluble gas or precipitating. In most reactions, UV or HVD bond-cracking upon reactant gas is always favoring the reaction at all, though some may require different parameter settings or maybe not necessary and then shortcut of the UV or HVD module is easy.

### ALL ASSOCIATED DRAWINGS LIST TABLE AND POSTSCRIPT

FIG. 1 The regular Rankine cycle

FIG. 2 Typical ejector construct and symbol

FIG. 3 Wei-II cycle engine rationale sketch with liquid motive flow

FIG. 4 Wei-II cycle engine rationale sketch with steam motive flow

FIG. 5 A clean energy or free energy engine based on Wei-II cycle

FIG. 6 A clean energy engine based on Wei-II cycle with electric field evaporation booster

FIG. 6a A clean energy engine with seawater-to-freshwater production based-on FIG. 6

FIG. 7 Electric field can promote evaporation rate (Asakawa Effect)

FIG. 8 An external combustion engine utilizing low pressure hydraulic motor

FIG. 9 A clean energy engine with turbine driven by flow of ballasted liquid in a tank

FIG. 9a A clean energy engine with seawater-to-freshwater production based on FIG. 9

FIG. 10 A clean energy engine with turbine driven by flow from high-rise water column

FIG. 11 Stacked evaporation-pan rack for increasing land use efficiency

FIG. 12 A compact fueled engine with turbine driven by flow of ballasted liquid

FIG. 12a A power plant with parasitic desalination freshwater plant based on FIG. 12

FIG. 12b A power plant with vacuum co-generation capacity based on FIG. 12

FIG. 13 A simple Wei-II cycle modification to regular power-plant with 2nd generator

FIG. 13a The simplest modification to Rankine cycle heat engine

FIG. 14 Another Wei-II cycle modification to regular power-plant with 2nd generator

FIG. 15 Wei-II cycle stage to claim water vapor in flue gas, and de-NOx & de-502

FIG. 16 Wei-II cycle stage to sequestrate carbon from flue gas by lime

FIG. 17 Wei-II cycle stage to sequestrate carbon from flue gas by quasi Solvay process

FIG. 18 Ejector working in condition of immersed internal combustion

FIG. 19 An immersed internal combustion engine based on Wei-II cycle

FIG. 20 An immersed combustion engine with ammonia synthesis production

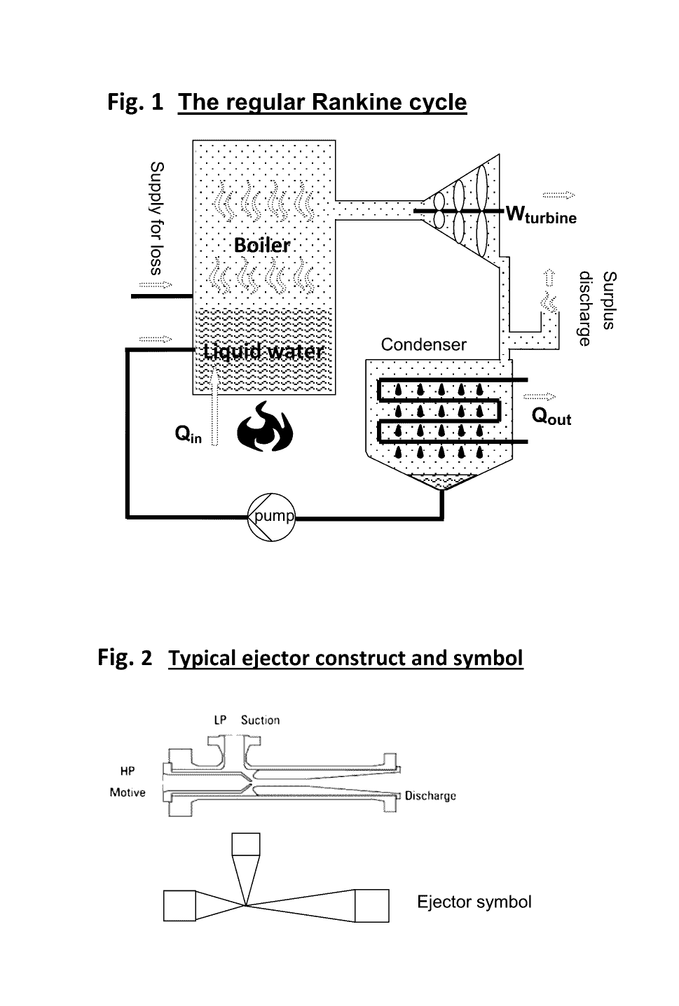

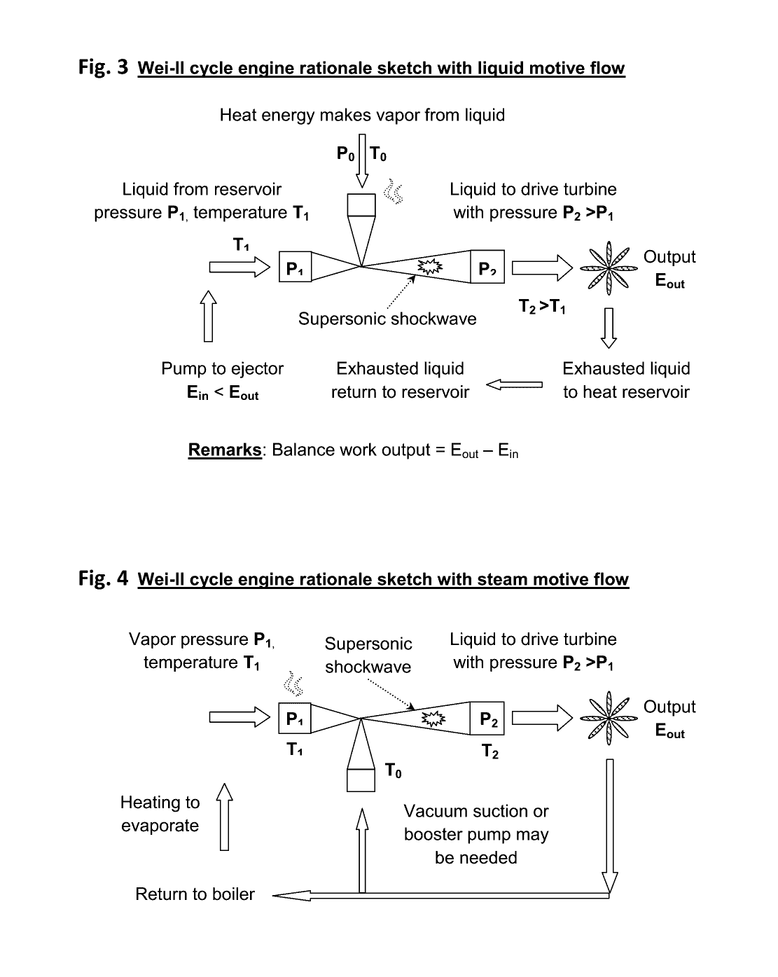

### POSTSCRIPT

Fluid pathway always prefers as smooth as possible, otherwise flowing resistance will be detrimental to system performance.

Although most pathways that are embodied in pipelines in above listed figures, appear in perpendicular angles, in fact, it should be understood that the real products can be smoothly curved with whatever means.

### CLAIMS

The inventions are described and expressed in the well-illustrated modalities. All those contain key implementing methods and/or procedures, and may be embodied in other specific forms or consisted of different working medium configurations, even parameter configurations without departing from its spirit or essential characteristics.

As mentioned in the foregoing description block, the geometrical parameters of ejector are paramount in importance to system performance, though roughly chosen parameter settings may still work. The optimized parameters are always depending on those different embodiments. Recipe-like geometric parameters configuration can be reserved for further protection of the intelligent property as the second shield.

All the illustrated modalities and the embedded modalities as modification of existing heat engine include powerplant are claimed as the at least protected scopes, and therefore, the said modalities' respective schematic figures can be deemed as the topological “fingerprints” of the subject inventions.

Some figures come with embedded comments or remarks, and the said comments or remarks also make properties of the said metaphorical fingerprints.

Any embodiment which schematic topology substantially matches any of the said figures is deemed as falling in the protection scope, and of course, it is also matchable for any new derived variety based on herein modalities by any other party, or in other words, all changes which come within the meaning and range of equivalency of the claims are to be embraced within their scope.

The root invention is a generic Wei-II cycle heat engine.

As to the wording, hereinafter, “and/or” stands for 2 possibilities: “AND” logic and “OR” logic, that means either existence or non-existence is acceptable; if (s) is suffixed to a noun word, it means it can be ONE piece or a plurality of pieces.

Although many invention points are enlightened in the main body of description, as some of those are derived from other points in just one step higher hierarchic logic, so I only list and claim the top important inventions as follows:

I claim:

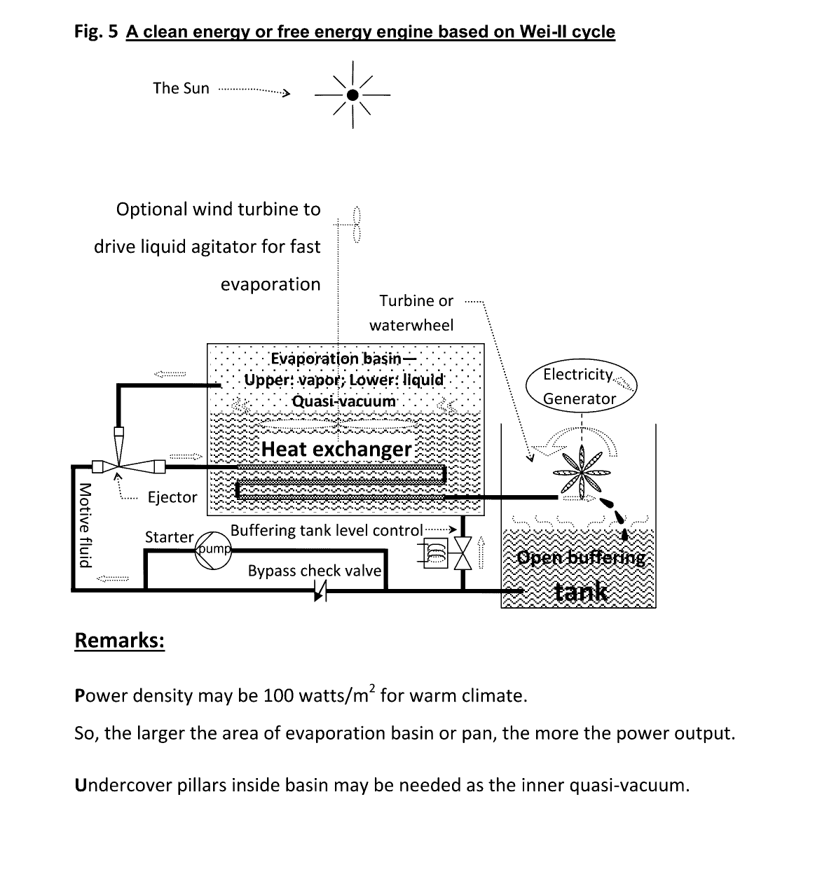

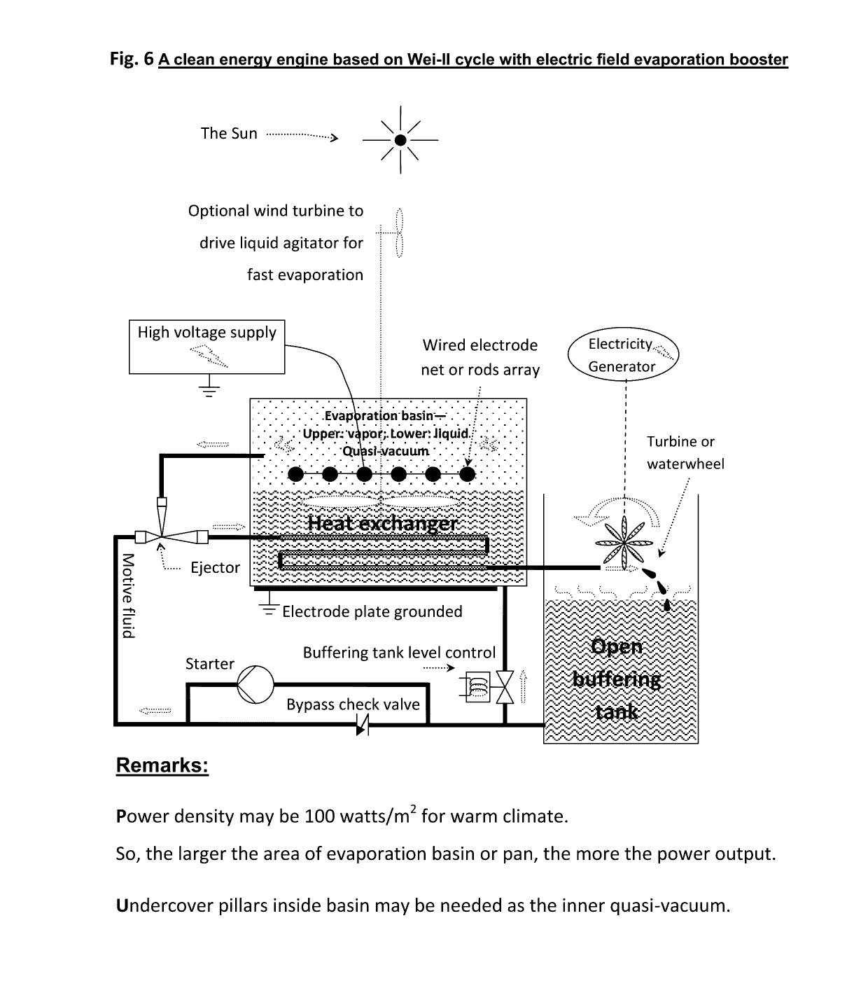

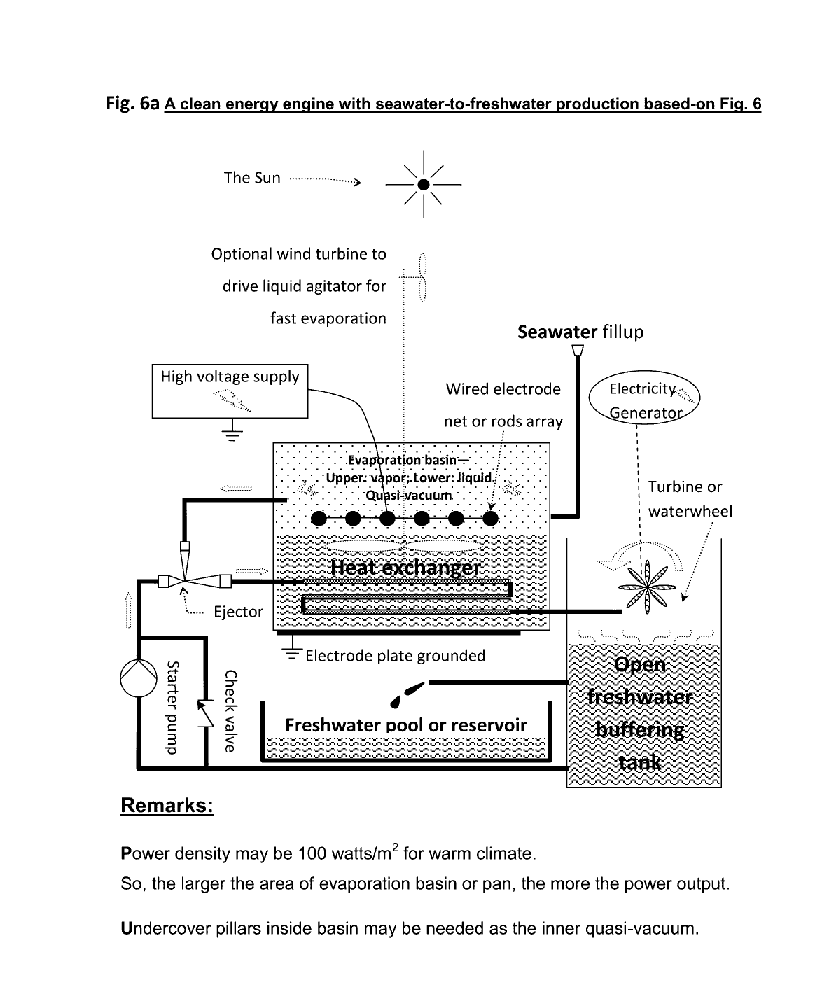

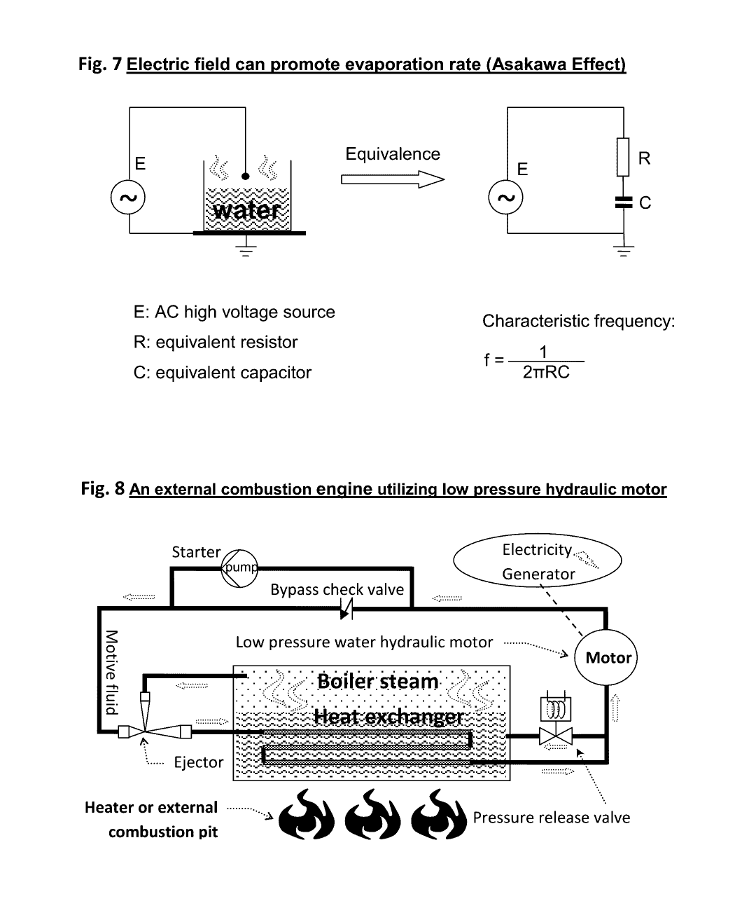

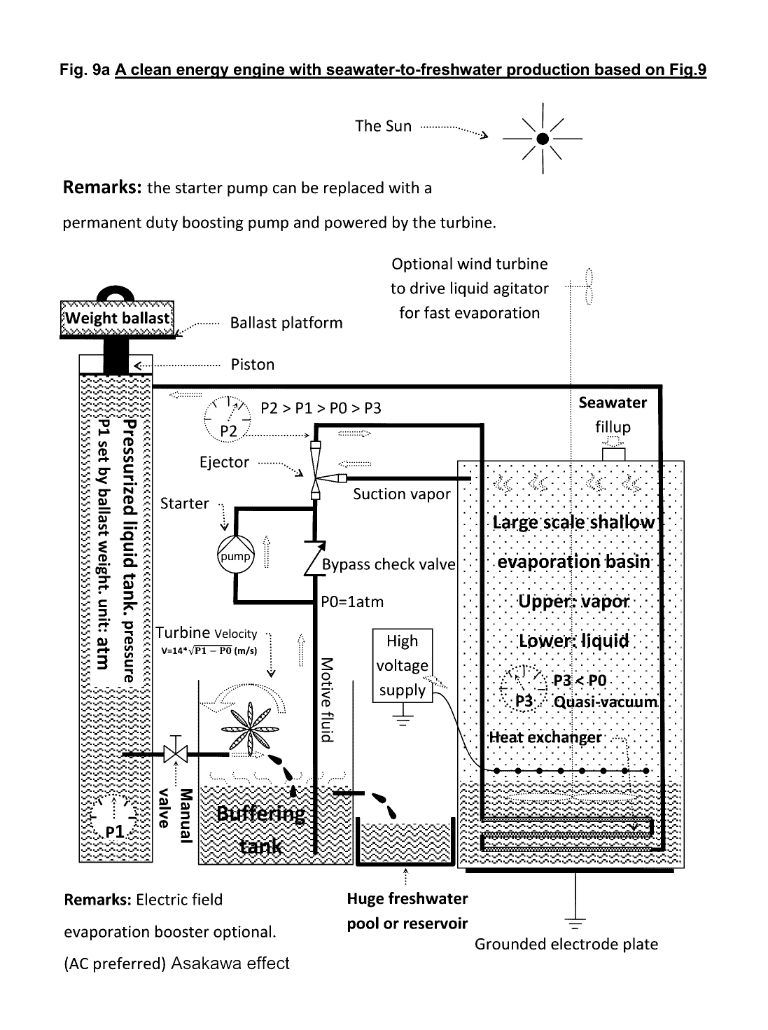

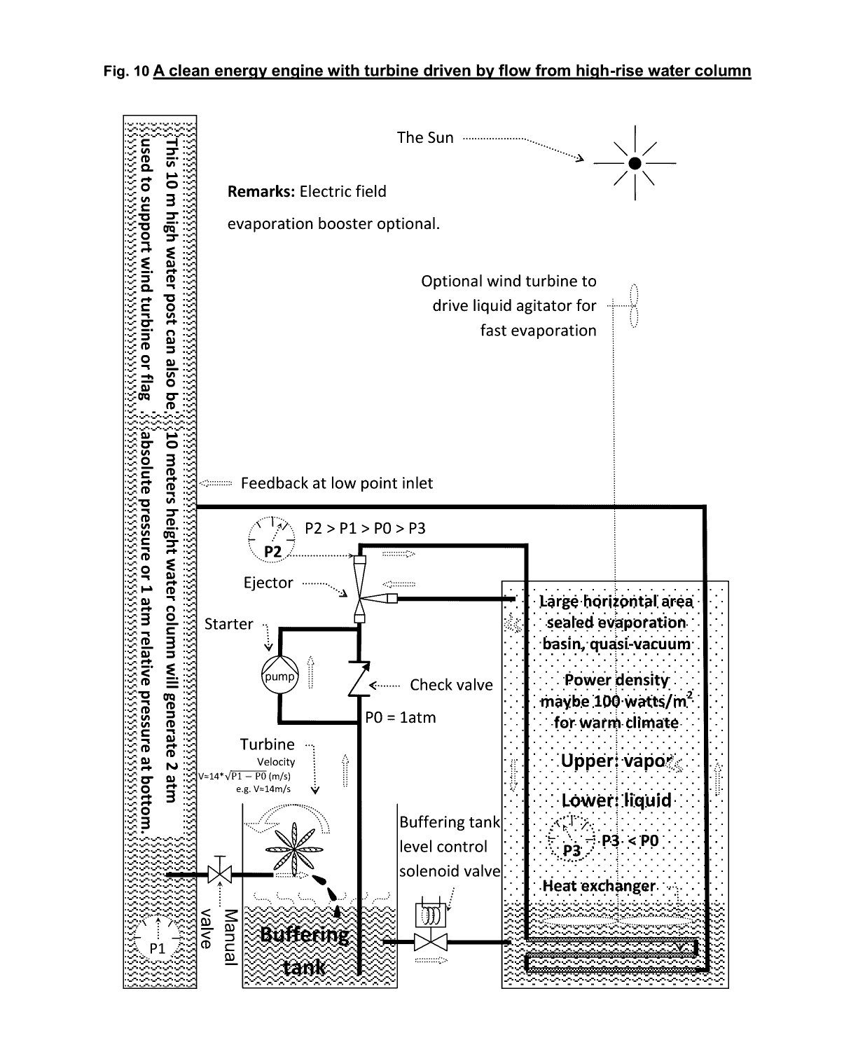

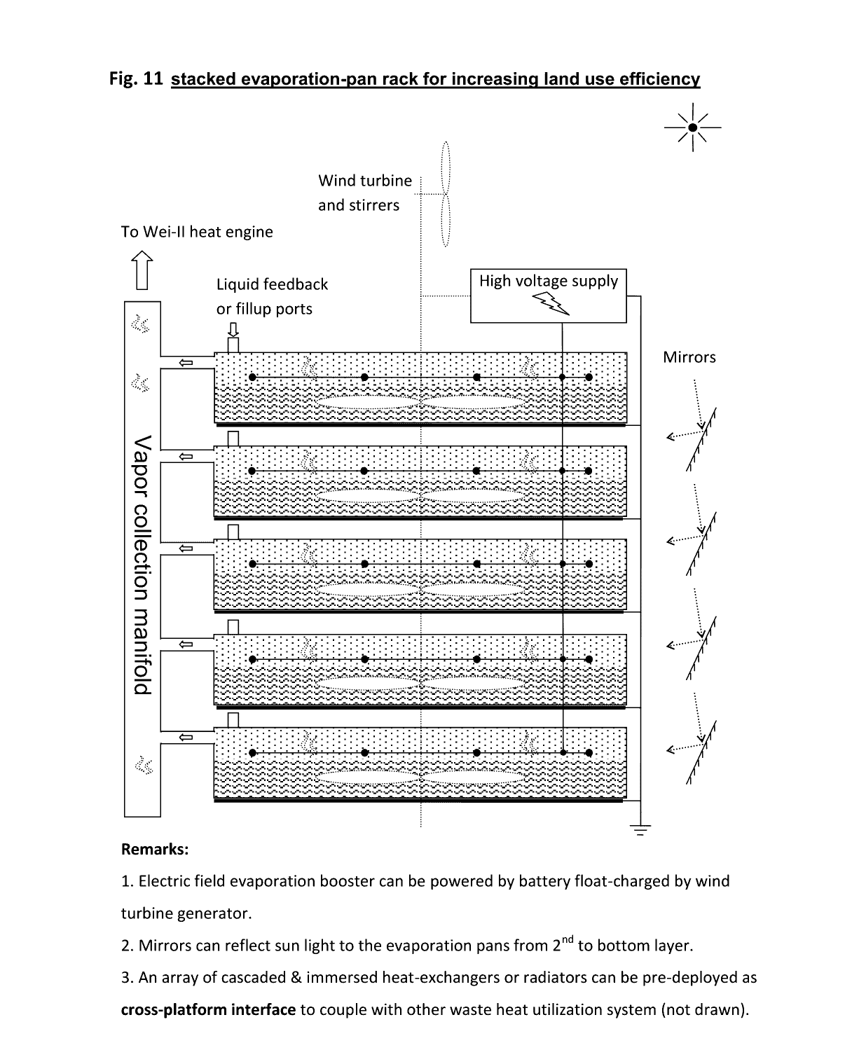

1. A series of clean energy generation modalities which topology can be abstracted or sketched as any one figure amongst FIGS. 5, 6, 6a,9, 9a, and 10, notwithstanding different application orientation.
1.1. In addition to claim 1, all modalities of the said series commonly comprising ejector(s), waterwheel-style turbine, starting pump, evaporation basin, and buffering tank; and the power output terminal is the said thereof turbine.
1.2. Subdividedly to claim 1, the modalities showed in FIGS. 6a and 9a is oriented to freshwater production by a specific means of desalination expressed in the foregoing description and figures.
1.3. Optionally to claim 1, and/or a wind turbine and/or electric-field activator is preferably used to boost the evaporation speed, and the former drives the immersed stirrer(s) as well as the latter comprising high voltage supply and electrodes that are adequately deployed.
1.4. Optionally to claim 1, the regular sprawling evaporation basin can be replaced by a stacked evaporation-pan rack which topology is illustrated in FIG. 11, plus multiple choices such as flexible layer quantity, electric field boosting module, stirrer(s) driven by wind turbine, the plumber interface of pre-immersed heat exchanger array for external waste heat input, and mirrors for reflection of sunshine.

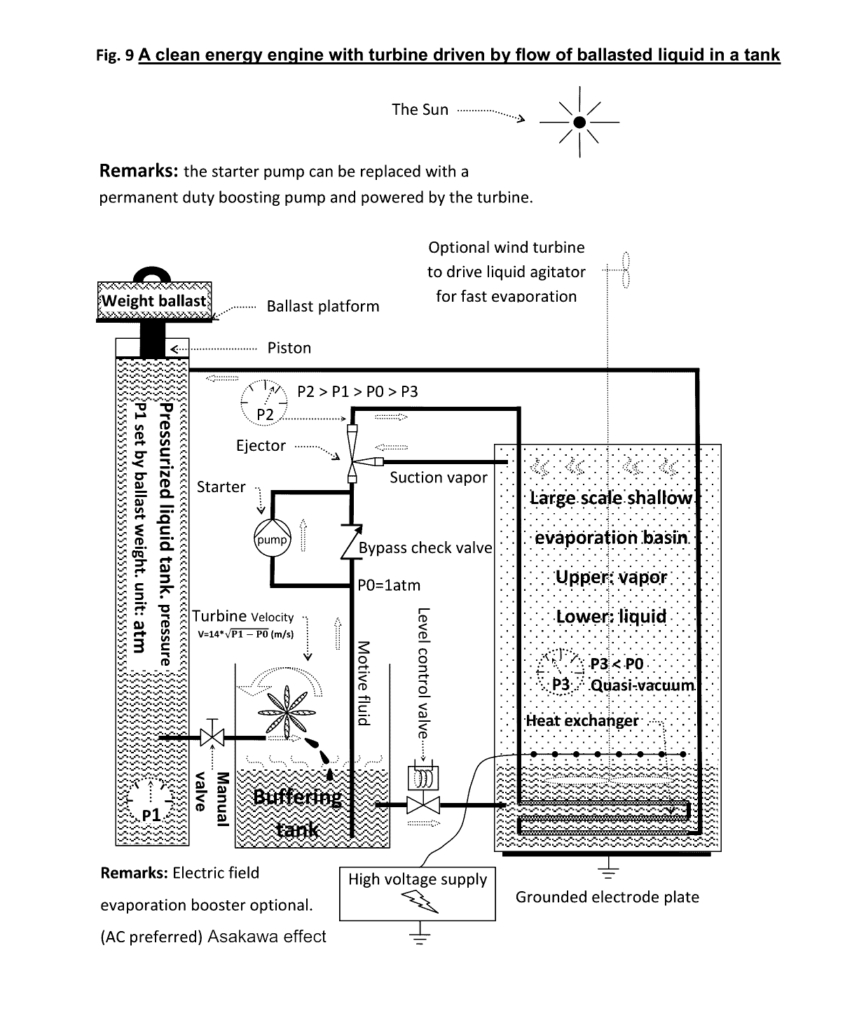

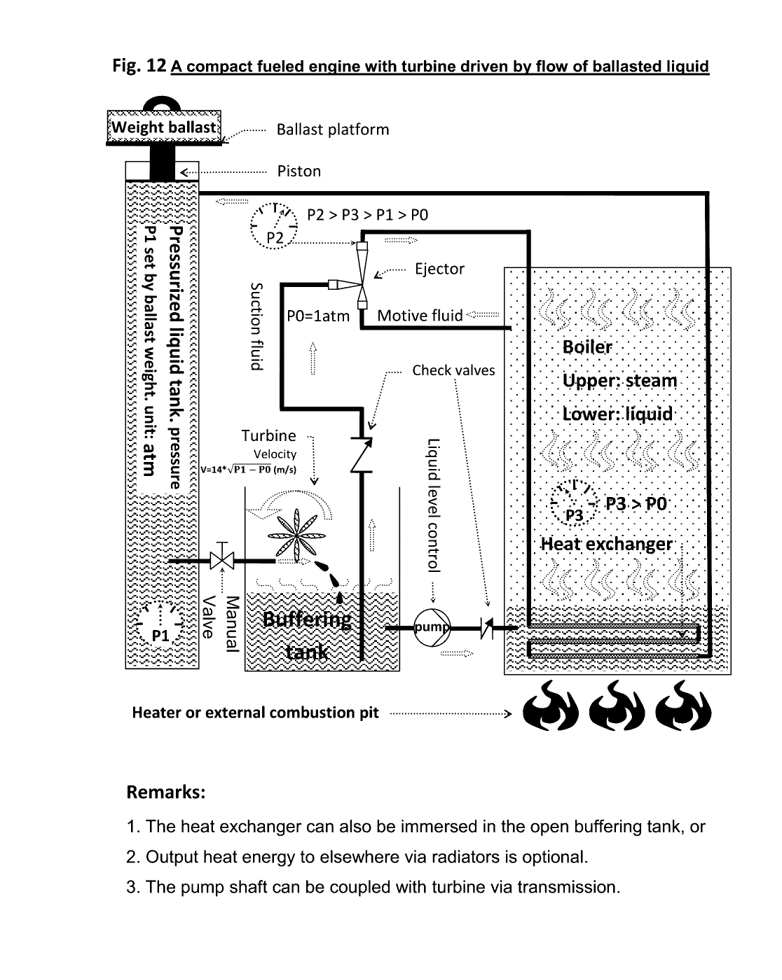

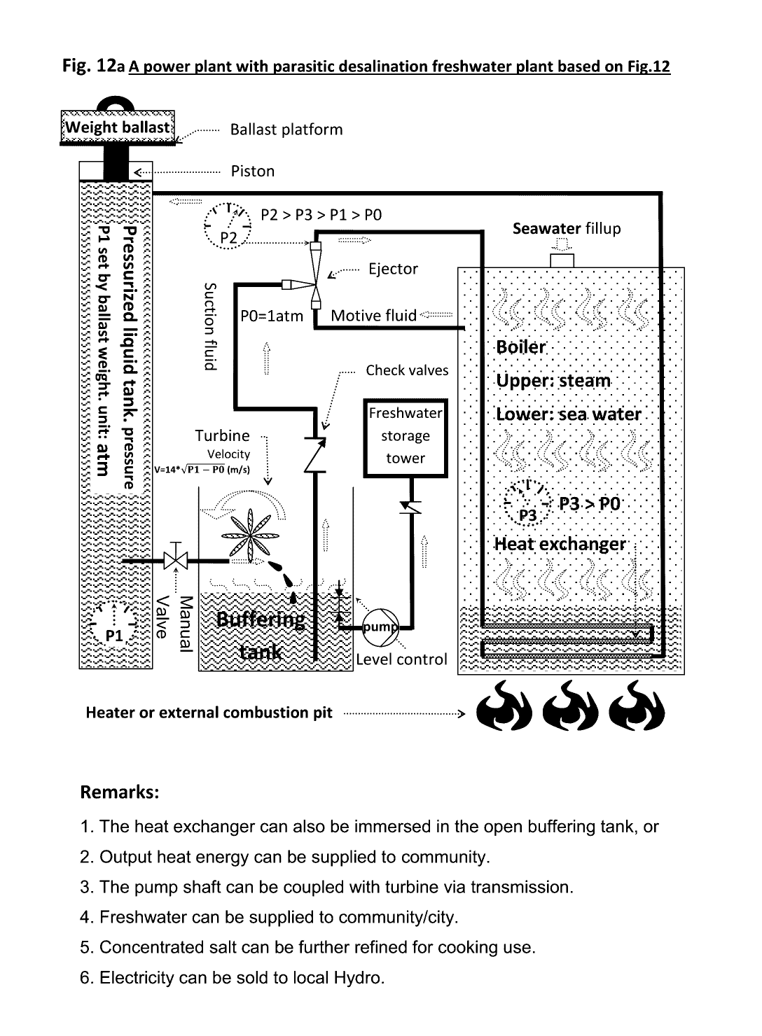

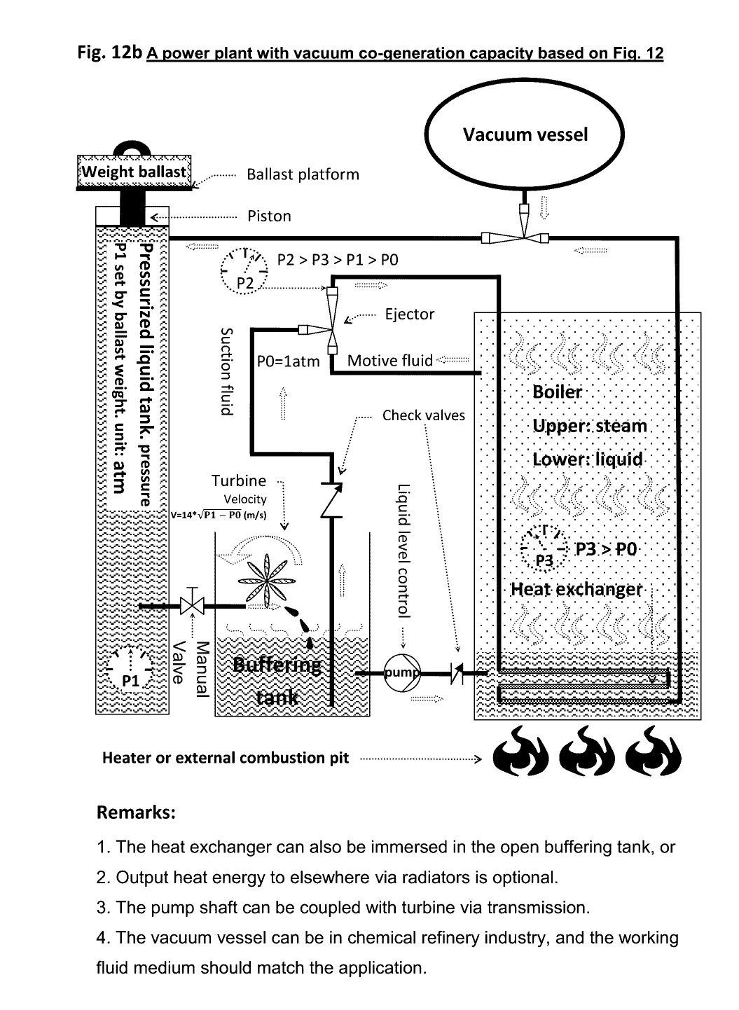

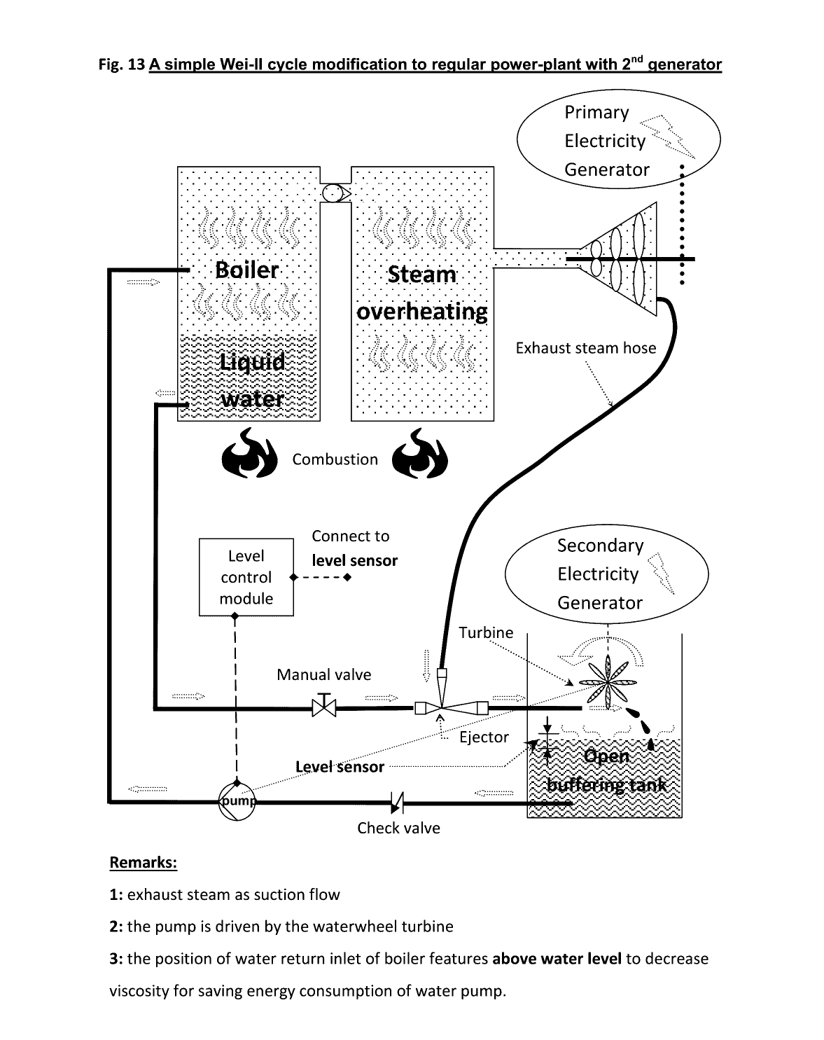

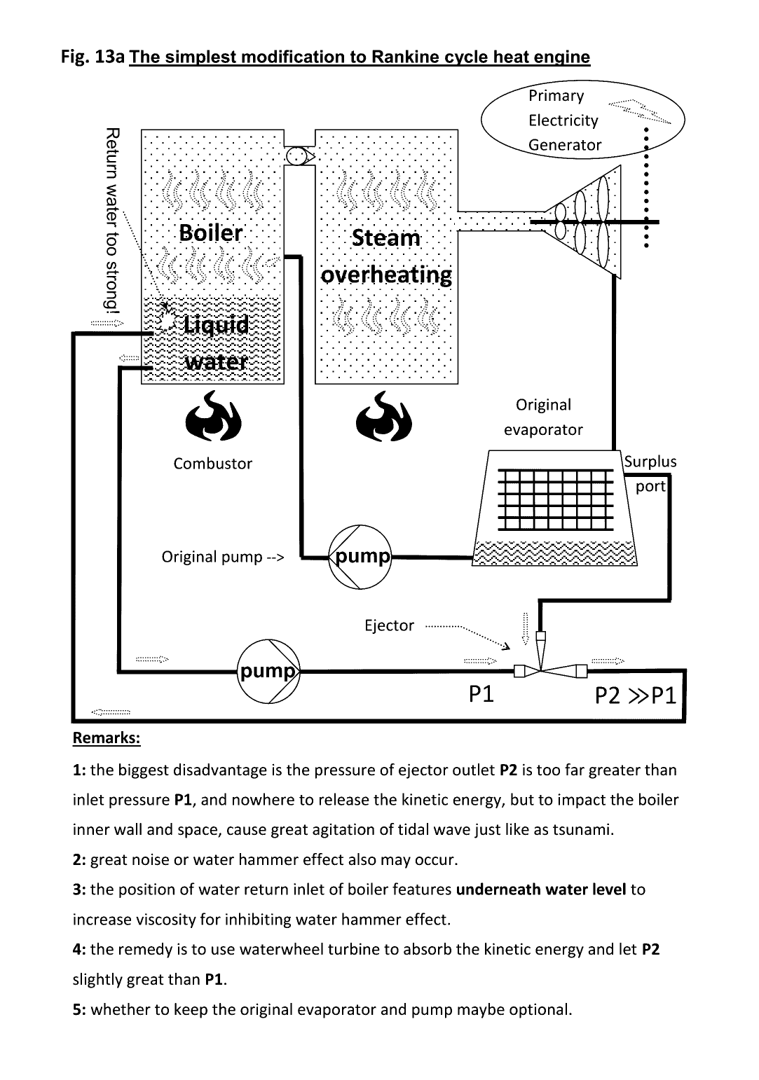

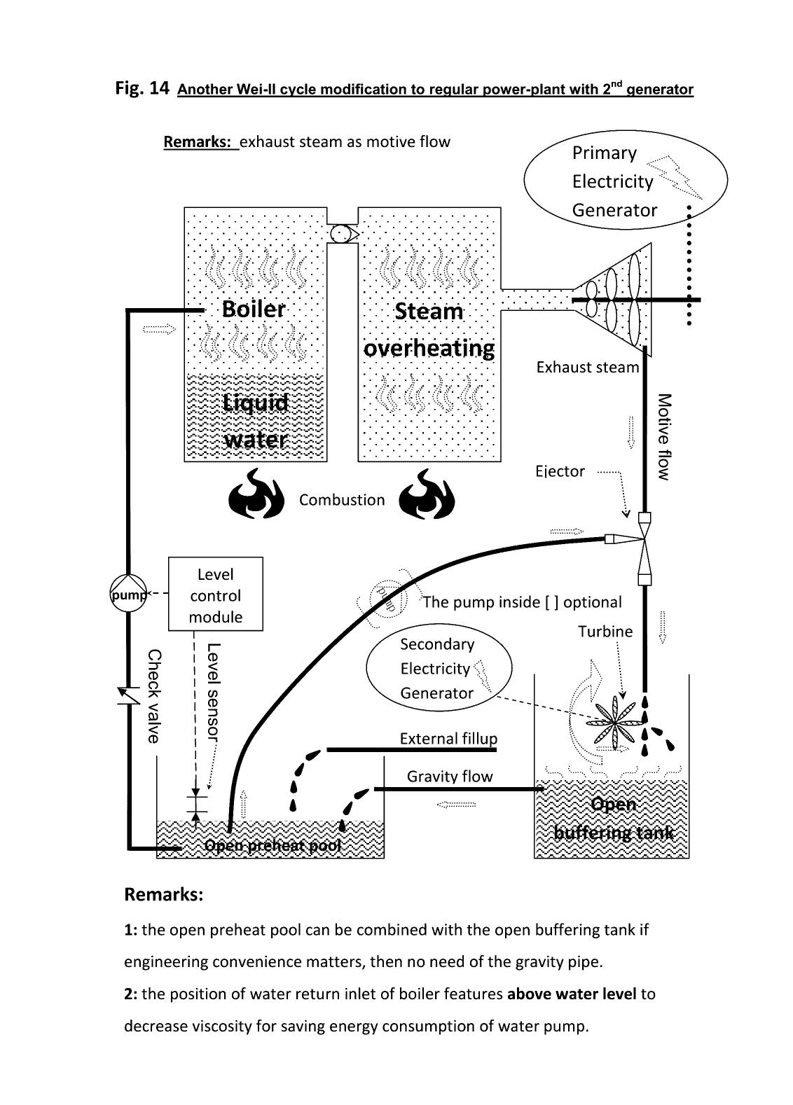

2. A series of modalities of external combustion engines which topology can be abstracted or sketched as any one figure amongst FIG. 8, 12, 12a, 12b plus the embedded version FIGS. 13, 13a, and 14, notwithstanding different application orientation.
2.1. In addition to claim 2, all modalities of the said series commonly comprising ejector(s), waterwheel-style turbine, evaporation basin, buffering tank, and combustor; and the power output terminal is the said thereof turbine.
2.2. Subdividedly to claim 2, the modality showed in FIG. 12a is oriented to freshwater production by a specific means of desalination expressed in the foregoing description and figure.
2.3. Subdividedly to claim 2, the modality showed in FIG. 12b is oriented to vacuum generation and retain by inserting dedicated ejector(s) which detail is expressed in the foregoing description and figure.
2.4. Subdividedly to claim 2, the modalities showed in FIGS. 13, 13a, and 14 is oriented to be embedded in the modification plan of existing powerplant or regular heat engine by a specific means of interfaces in the foregoing description and figures.
In this subdivision, for the so-called simplest modality in FIG. 13a without a turbine as the only exception, the position of water return inlet of boiler features below water level to increase viscosity for inhibiting water hammer effect; as well as for the modalities in FIGS. 13 & 14, the position of water return inlet of boiler features above water level to decrease viscosity for saving energy consumption of water pump.

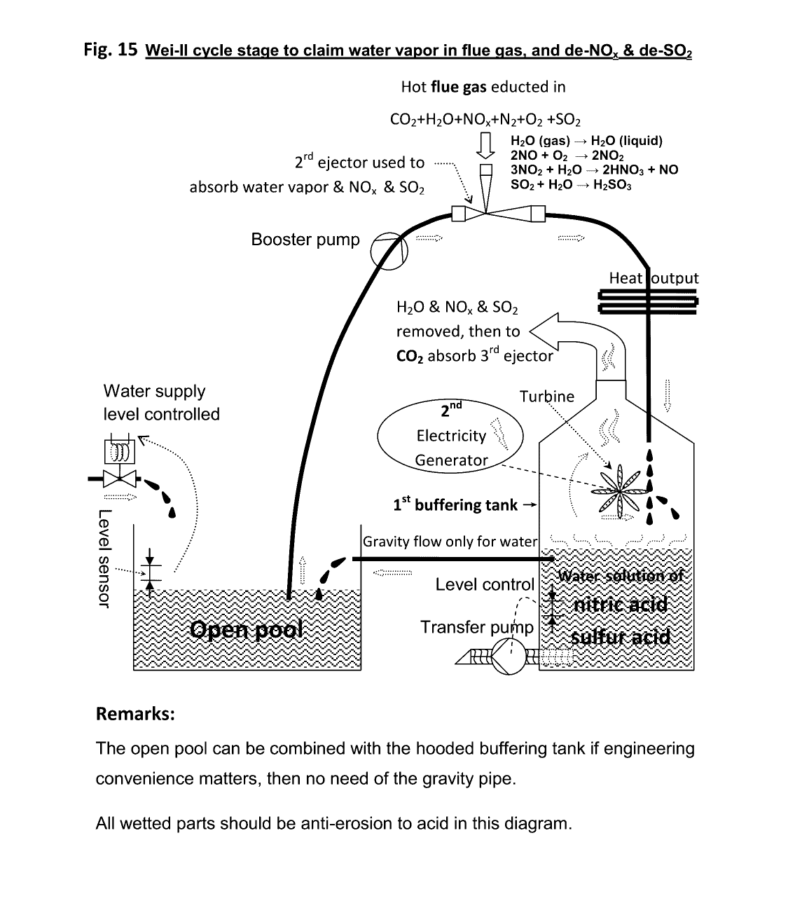

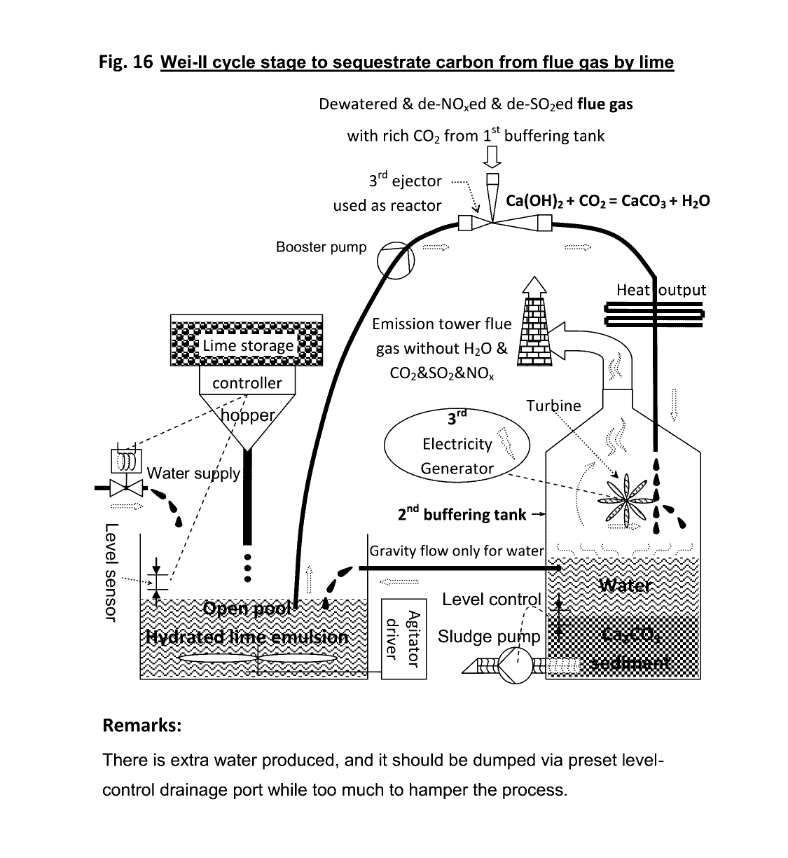

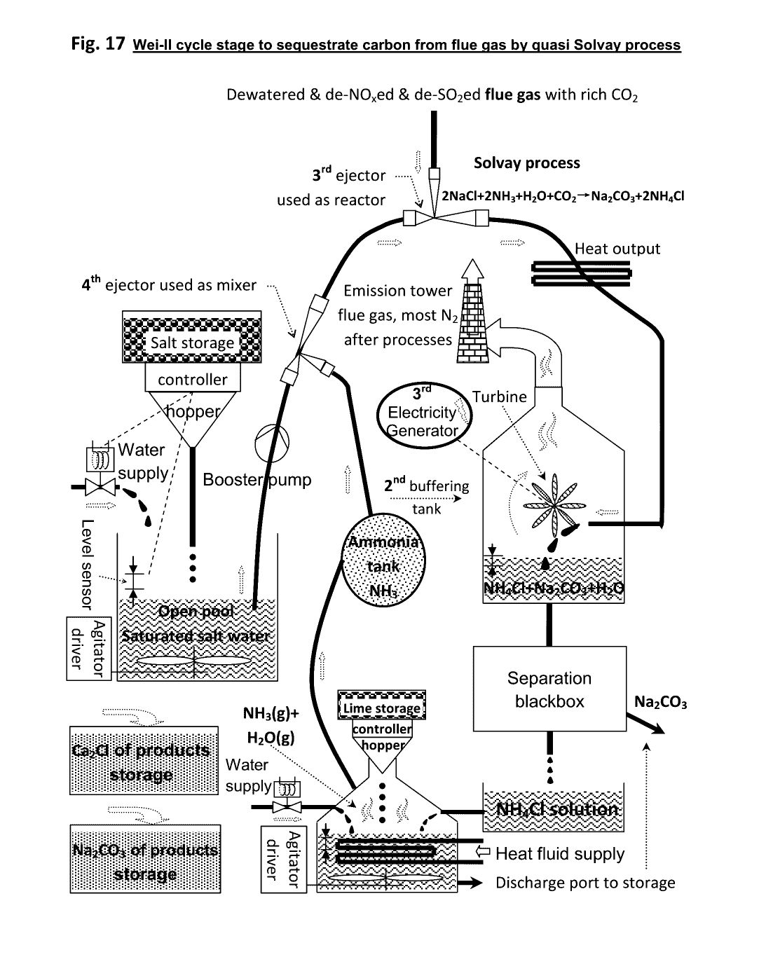

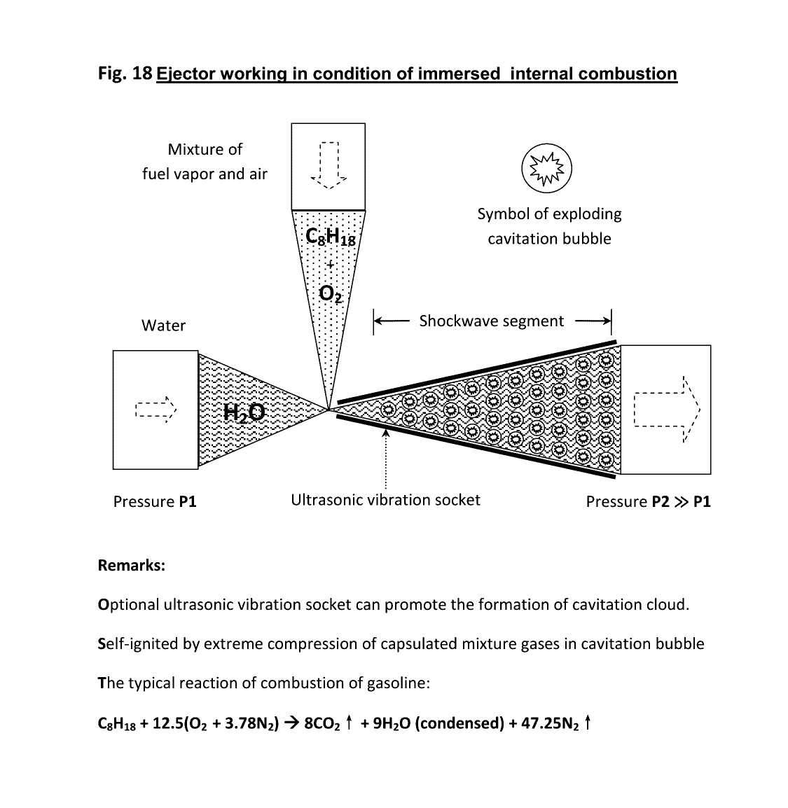

3. A series of modalities of flue gas process which topology can be abstracted or sketched as any one figure amongst FIGS. 15, 16, and 17, notwithstanding different objective orientation.
3.1. In addition to claim 3, all modalities of the said series commonly comprising ejector(s), waterwheel-style turbine, starting or boosting pump, hooded buffering tank(s), open pool(s), heat exchanger(s), and products transfer pump(s) or conveyor(s).
The power output terminal is the said thereof turbine; and the heat output terminal is the said thereof heat exchanger that inlined in the hot jet flow pipeline.
3.2. In addition to claim 3, at least one ejector will be used as chemical reaction vessel that hosts the dedicated easy and quick non-equilibrium chemical reaction.
3.3. In addition to claim 3, as all prime reactions are exothermic and large amount heat can be generated, the dedicated heat output can be implemented by routing the hot jet flow to elsewhere heat energy consuming space via radiator(s).
3.4. In addition to claim 3, boosting pump should be fitted into the pipeline of motive flow to cope with the large scale flux of flue gas.
3.5. Subdividedly to claim 3, the modality illustrated in FIG. 15 is oriented to at least the purpose of capturing combustion-produced water vapor and its latent heat; additional purposes include capturing NOₓ and SO₂ for pollution control; and the produced nitric acid and sulfur acid can be further refined for commercial products.
The more detail is expressed in the foregoing description and figure.
3.6. Subdividedly to claim 3, modality illustrated in FIG. 16 is oriented to capture CO₂ by means of reaction with lime with the last resultant: solid calcium carbonate, though a process of non-profitable then less motivation.
Besides the said common components, also it comprises lime storage and attached feeding hopper, and agitator for making hydrated lime emulsion.
The more detail is expressed in the foregoing description and figure.
3.7. Subdividedly to claim 3, modality illustrated in FIG. 17 is oriented to capture CO₂ by hosting a parasitic soda factory; it works technically by the quasi Solvay process.
Besides the said common components, also it comprises lime storage and attached feeding hopper, salt storage and attached feeding hopper, agitators for making hydrated lime emulsion & saturated salt aqua solution, ammonium chloride buffering tank, and compounds separation module.
The more detail is expressed in the foregoing description and figure.
3.8. In addition to claim 3, the subdivision of H₂O+NOₓ+SO₂ sequestration process can be deployed sequentially ahead of any subdivision of CO₂ sequestration process.
In this sequence-process scenario, the previous processed flue gas is fed into the next process, and the last processed flue gas is the cleanest flue gas that mainly contains the neutral gas nitrogen N₂, and then let it route to the chimney as the final emission.

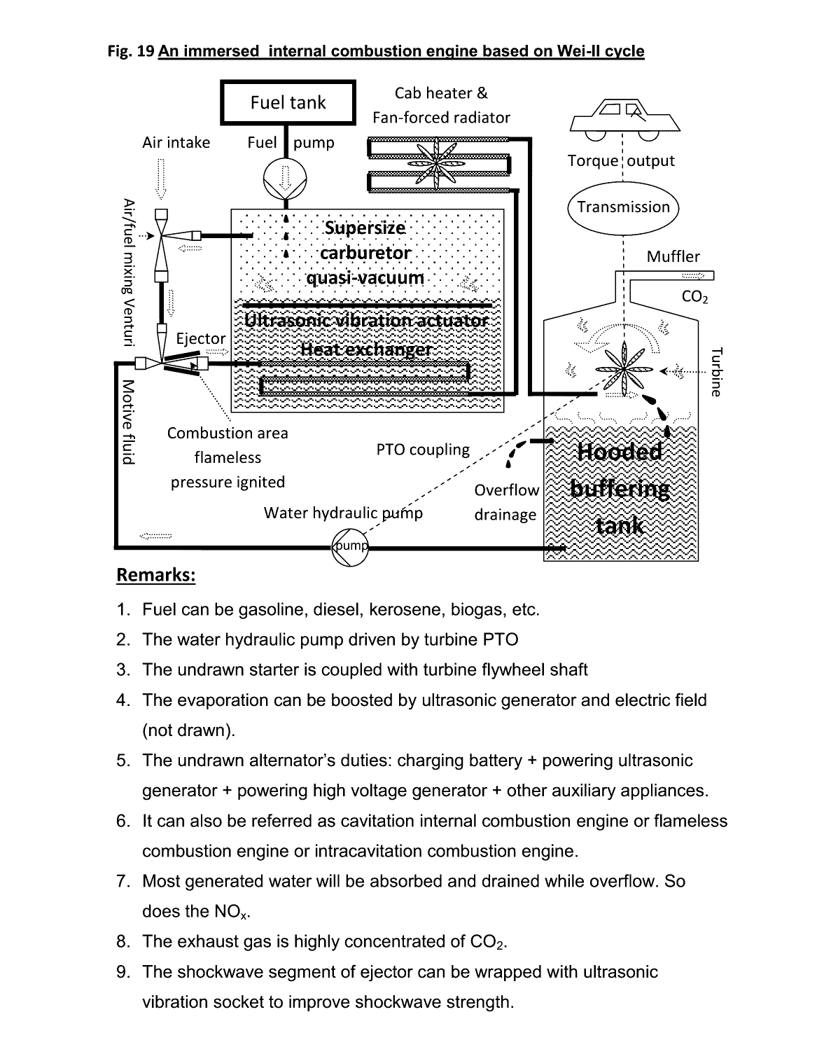

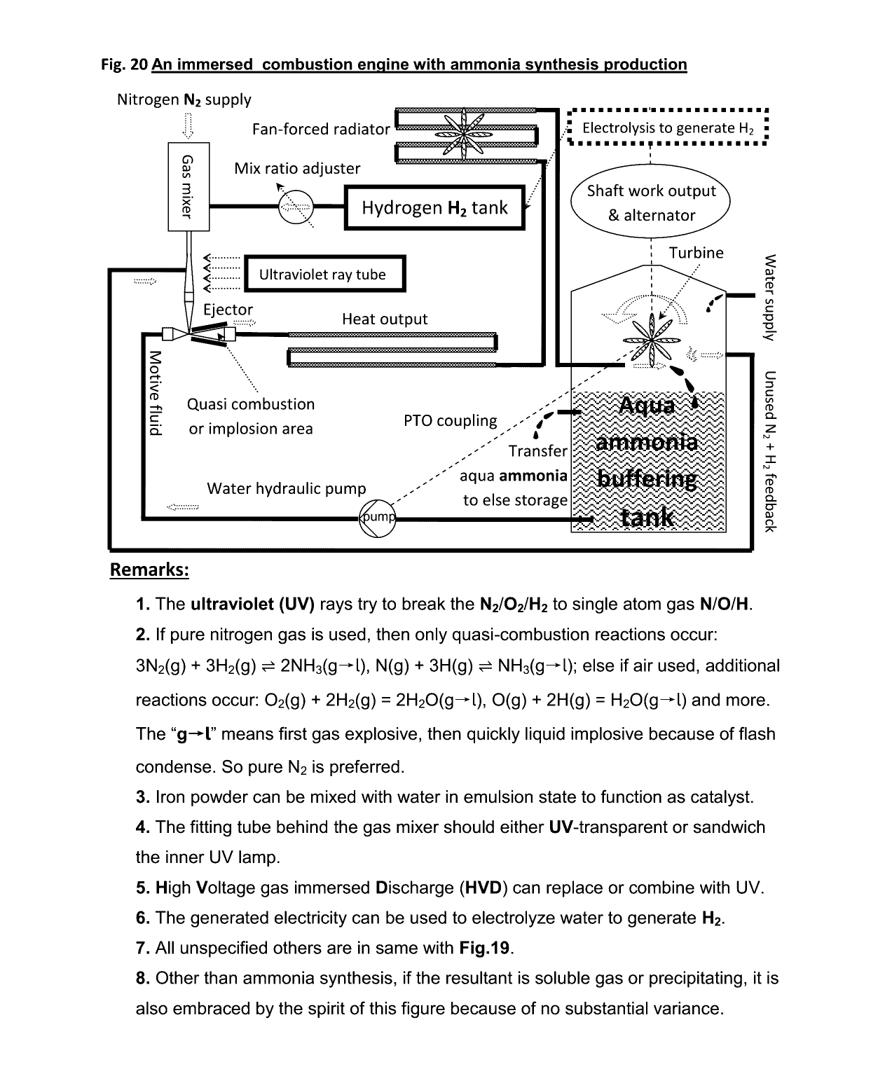

4. A series of modalities of the immersed internal combustion engine which topology can be abstracted or sketched as any one figure amongst FIG. 19 for liquid fuel and FIG. 20 for gaseous fuel, and commonly comprise: ejector, waterwheel style turbine, buffering tank, water hydraulic pump, heat exchanger(s), and starter. Auxiliary or peripheral parts comprise ultrasonic generator, ultrasonic socket of the ejector, alternator or generator, and one or more batteries.
4.1. In addition to claim 4, an engine modality for liquid fuel version can be embodied, additionally comprising fuel tank, fuel pump, peculiar carburetor, and fuel mixer that a style of Venturi is recommended. Auxiliary or peripheral parts optionally comprise choke, throttle, fan-forced radiator and/or space heater, muffler.
It features that the mixture of oxygen or air and fuel vapor is inducted into ejector by motive flow of uninflammable liquid then combustion bursts inside shockwave segment of ejector because of high temperature self-ignition caused by high compression of cavitation, and then power and heat combined generation can be harvested therein.
4.1.1. In addition to claim 4.1, to cope with the risk of freezing in winter, proper anti-freezer liquid should be added to the circulating fundamental liquid in a proper proportion to tune-up the desired freezing point temperature. The anti-freezer should not dissolve fuel so as not to degrade the power performance.
4.1.2. Optionally to claim 4.1, an ultrasonic vibration actuator can be immersed under fuel liquid inside the said peculiar carburetor, in order to atomize fuel or boost the fuel evaporation; and another ultrasonic vibration socket can be fitted to the shockwave segment of the said ejector if desire to promote the formation of cavitation cloud.
4.2. In addition to claim 4, an engine modality for special gaseous fuel version can be embodied with the 2^{nd} purpose of important soluble gaseous or precipitating chemical production, e.g. ammonia synthesis, additionally comprising one or both of ultraviolet (UV) module and High Voltage immersed gas Discharge (HVD) module, feedback gas circuit of unused mixture (e.g. N₂+H₂) that bridges the sealed buffering tank and gas inlet of the ejector. Auxiliary or peripheral parts optionally comprise raw gases supply vessels (e.g. H₂ & N₂), valves, product transfer pump, water supply pump.
It features that the mixture gases are partially pre-cracked by UV rays and/or the equivalent HVD into single atom state so as to in joint effort with the compression induced high temperature do facilitate the oncoming ignition in cavitation bubbles, as well as power and heat combined generation can be obtained in the ejector-hosted reactor.
4.3. If the gaseous-fuel-involved combustion can produce CO₂ or other insoluble gaseous resultant(s), it should be automatically categorized into the sub-modality of the aforementioned claim 4.1—the liquid fuel version, e.g. the fuel propane, because everywhere is same behind the carburetor for liquid fuel evaporation.
More less-meaning features and options are expressed and indicated in the foregoing description and figure.
